(19) United States
(12) Patent Application Publication
(10) Pub. No.: US 2023/0276476 A1
(43) Pub. Date: Aug. 31, 2023

(54) METHODS AND APPARATUSES FOR RESOURCE ALLOCATION TO TERMINAL DEVICE

(71) Applicant: Telefonaktiebolaget LM Ericsson (publ), Stockholm (SE)

(72) Inventors: Zhang ZHANG, Beijing (CN); Min WANG, Luleå (SE); Antonino ORSINO, Masala (FI)

(73) Assignee: Telefonaktiebolaget LM Ericsson (publ), Stockholm (SE)

(21) Appl. No.: 18/040,126

(22) PCT Filed: Jul. 27, 2021
(86) PCT No.: PCT/CN2021/108703

§ 371 Date: Jan. 31, 2023

(30) Foreign Application Priority Data
Aug. 6, 2020 (WO) PCT/CN2020/107466

(51) Int. Cl. H04W 72/52; H04W 28/02; H04W 72/04

(52) U.S. Cl. CPC H04W 72/52; H04W 28/0278; H04W 72/04; H04W 88/04

(57) ABSTRACT

Methods and apparatuses for resource allocation to a terminal device. In a method a first terminal device connects to a network via a second terminal device acting as a relay therebetween. The first terminal device transmits, to the second terminal device, a report message comprising at least information related to a volume of data from the first terminal device to the second terminal device.

### TECHNICAL FIELD

Embodiments of the disclosure generally relate to communication, and, more particularly, to methods and apparatuses for resource allocation to terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

Similar to long term evolution (LTE), new radio (NR) uses orthogonal frequency division multiplexing (OFDM) in the downlink (i.e. from a network node such as a base station to a user equipment (UE)). The basic NR physical resource over an antenna port can thus be seen as a time-frequency grid as illustrated in FIG. 1, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing (SCS) values (also referred to as different numerologies) are given by Δf=(15×2\hat{ }μ) kHz where μ∈(0,1,2,3,4). Δf=15 kHz is the basic (or reference) subcarrier spacing that is also used in LTE.

In the time domain, downlink and uplink transmissions in NR will be organized into equally-sized subframes of 1 ms each similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz and a slot consists of 14 OFDM symbols.

Downlink transmissions are dynamically scheduled, i.e., in each slot the next generation node base station (gNB) transmits downlink control information (DCI) about which UE data is to be transmitted to and which resource blocks in the current downlink slot the data is transmitted on. This control information is typically transmitted in the first one or two OFDM symbols in each slot in NR. The control information is carried on the physical downlink control channel (PDCCH) and data is carried on the physical downlink shared channel (PDSCH). A UE first detects and decodes PDCCH and if a PDCCH is decoded successfully, it then decodes the corresponding PDSCH based on the downlink assignment provided by the decoded control information in the PDCCH.

In addition to PDCCH and PDSCH, there are also other channels and reference signals transmitted in the downlink, including synchronization signal block (SSB), channel state information reference signal (CSI-RS), etc.

Uplink data transmissions, carried on physical uplink shared channel (PUSCH), can also be dynamically scheduled by the gNB by transmitting a DCI. The DCI (which is transmitted in the downlink (DL) region) always indicates a scheduling time offset so that the PUSCH is transmitted in a slot in the uplink (UL) region.

As described in the 3rd generation partnership project (3GPP) technical specification (TS) 38.321 V16.0.0 clause 5.4.5, the buffer status reporting (BSR) procedure is used to provide the serving gNB with information about UL data volume in the media access control (MAC) entity. In the case of integrated access backhaul (IAB), it is additionally used by an IAB mobile termination (IAB-MT) to provide its parent IAB distributed unit (IAB-DU) with the information about the amount of the data expected to arrive at the MT of the IAB node from its child node(s) and or UE(s) connected to it. This BSR is referred to as pre-emptive BSR.

Further details from 3GPP TS 38.321 V16.0.0 clause 5.4.5 are as follows:

For any BSR other than a pre-emptive BSR, radio resource control (RRC) configures the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup.
   Each logical channel may be allocated to a logical channel group (LCG) using the logicalChannelGroup. The maximum number of LCGs is eight. The MAC entity determines the amount of UL data available for a logical channel according to the data volume calculation procedure.
   A BSR other than a pre-emptive BSR shall be triggered if any of the following events occur:
UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
in which case the BSR is referred below to as ‘Regular BSR’;
UL resources are allocated and the number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.
NOTE 1: When a Regular BSR triggering events occurs for multiple logical channels simultaneously, each logical channel triggers one separate Regular BSR.
   If configured, a pre-emptive BSR may be triggered for the specific case of an IAB-MT if any of the following events occur:
a UL grant is provided to a child IAB node or UE;
a BSR is received from a child IAB node or UE.
   For a Regular BSR, the MAC entity shall:
1> if the BSR is triggered for a logical channel for which logicalChannelSR-DelayTimerApplied with value true is configured by upper layers:
   2> start or restart the logicalChannelSR-DelayTimer.
1> else:
   2> if running, stop the logicalChannelSR-DelayTimer.
      For Regular and Periodic BSR, the MAC entity shall:
1> if more than one LCG has data available for transmission when the MAC PDU containing the BSR is to be built:
   2> report Long BSR for all LCGs which have data available for transmission.
1> else:
   2> report Short BSR.
      For a Padding BSR, the MAC entity shall:
1> if the number of padding bits is equal to or larger than the size of the Short BSR plus its subheader but smaller than the size of the Long BSR plus its subheader:
   2> if more than one LCG has data available for transmission when the BSR is to be built:
      3> if the number of padding bits is equal to the size of the Short BSR plus its subheader:
         4> report a Short Truncated BSR of the LCG with the highest priority logical channel with data available for transmission.
      3> else:
         4> report a Long Truncated BSR of the LCG(s) with the logical channels having data available for transmission following a decreasing order of the highest priority logical channel (with or without data available for transmission) in each of these LCG(s), and in case of equal priority, in increasing order of LCGID.
   2> else:
      3> report a Short BSR.
1> else if the number of padding bits is equal to or larger than the size of the Long BSR plus its subheader:
   2> report a Long BSR for all LCGs which have data available for transmission.
      For a Pre-emptive BSR, the MAC entity shall:
1> report a Pre-emptive BSR.
   For a BSR triggered by retxBSR-Timer expiry, the MAC entity considers that the logical channel that triggered the BSR is the highest priority logical channel that has data available for transmission at the time the BSR is triggered.
   The MAC entity shall:
1> if the Buffer Status reporting procedure determines that at least one BSR other than Pre-emptive BSR has been triggered and not cancelled:
   2> if UL-SCH resources are available for a new transmission and the UL-SCH resources can accommodate the BSR MAC CE plus its subheader as a result of logical channel prioritization:
      3> instruct the Multiplexing and Assembly procedure to generate the BSR MAC CE(s);
      3> start or restart periodicBSR-Timer except when all the generated BSRs are long or short Truncated BSRs;
      3> start or restart retxBSR-Timer.
   2> if a Regular BSR has been triggered and logicalChannelSR-DelayTimer is not running:
      3> if there is no UL-SCH resource available for a new transmission; or
      3> if the MAC entity is configured with configured uplink grant(s) and the Regular BSR was triggered for a logical channel for which logicalChannelSR-Mask is set to false; or
      3> if the UL-SCH resources available for a new transmission do not meet the LCP mapping restrictions (see clause 5.4.3.1 in the 3GPP TS 38.321) configured for the logical channel that triggered the BSR:
         4> trigger a Scheduling Request.
1> if the Buffer Status reporting procedure determines that at least one Pre-emptive BSR has been triggered and not cancelled:
   2> if UL-SCH resources are available for a new transmission and the UL-SCH resources can accommodate the Pre-emptive BSR MAC CE plus its subheader as a result of logical channel prioritization:
      3> instruct the Multiplexing and Assembly procedure to generate the Pre-emptive BSR MAC CE.
   2> else:
      3> trigger a Scheduling Request.
NOTE 2: UL-SCH resources are considered available if the MAC entity has an active configuration for either type of configured uplink grants, or if the MAC entity has received a dynamic uplink grant, or if both of these conditions are met. If the MAC entity has determined at a given point in time that UL-SCH resources are available, this need not imply that UL-SCH resources are available for use at that point in time.
   For the case when Pre-emptive BSR is being sent, a MAC PDU may contain one BSR MAC CE for Pre-emptive BSR, and one BSR MAC CE for BSR other than Pre-emptive BSR. A MAC PDU not containing a BSR MAC CE for Pre-emptive BSR shall contain at most one BSR MAC CE, even when multiple events have triggered a BSR. The Regular BSR and the Periodic BSR shall have precedence over the padding BSR.
   The MAC entity shall restart retxBSR-Timer upon reception of a grant for transmission of new data on any UL-SCH.
   All triggered BSRs other than Pre-emptive BSR may be cancelled when the UL grant(s) can accommodate all pending data available for transmission but is not sufficient to additionally accommodate the BSR MAC CE plus its subheader. All BSRs other than Pre-emptive BSR triggered prior to MAC PDU assembly shall be cancelled when a MAC PDU is transmitted, regardless of LBT failure indication from lower layers, and this PDU includes a Long or Short BSR MAC CE which contains buffer status up to (and including) the last event that triggered a BSR prior to the MAC PDU assembly. A Pre-emptive BSR shall be cancelled when a MAC PDU is transmitted and this PDU includes the corresponding Pre-emptive BSR MAC CE.
NOTE 3: MAC PDU assembly can happen at any point in time between uplink grant reception and actual transmission of the corresponding MAC PDU. BSR and SR can be triggered after the assembly of a MAC PDU which contains a BSR MAC CE, but before the transmission of this MAC PDU. In addition, BSR and SR can be triggered during MAC PDU assembly.
NOTE 4: Pre-emptive BSR may be used for the case of dual-connected IAB node. It is up to network implementation to work out the associated MAC entity or entities, and the associated expected amount of data. For the case of dual-connected IAB node, there may be ambiguity in Pre-emptive BSR calculations and interpretation by the receiving nodes in case where BH RLC channels mapped to different egress Cell Groups are not mapped to different ingress LCGs.
NOTE 5: If a HARQ process is configured with cg-RetransmissionTimer and if the BSR is already included in a MAC PDU for transmission by this HARQ process, but not yet transmitted by lower layers, it is up to UE implementation how to handle the BSR content.

BSR MAC control elements (CEs) consist of either: short BSR format (fixed size); or long BSR format (variable size); or short truncated BSR format (fixed size); or long truncated BSR format (variable size); or pre-emptive BSR format (variable size).

Further details from 3GPP TS 38.321 V16.0.0 clause 6.1.3 are as follows:

The BSR formats are identified by MAC subheaders with LCIDs as specified in Table 6.2.1-2.
The fields in the BSR MAC CE are defined as follows:
LCG ID: The Logical Channel Group ID field identifies the group of logical channel(s) whose buffer status is being reported. The length of the field is 3 bits;
LCGᵢ: For the Long BSR format, this field indicates the presence of the Buffer Size field for the logical channel group i. The LCGᵢ field set to 1 indicates that the Buffer Size field for the logical channel group i is reported. The LCGᵢ field set to 0 indicates that the Buffer Size field for the logical channel group i is not reported. For the Long Truncated BSR format, this field indicates whether logical channel group i has data available. The LCGᵢ field set to 1 indicates that logical channel group i has data available. The LCGᵢ field set to 0 indicates that logical channel group i does not have data available;
Buffer Size: The Buffer Size field identifies the total amount of data available according to the data volume calculation procedure in TSs 38.322 and 38.323 across all logical channels of a logical channel group after the MAC PDU has been built (i.e. after the logical channel prioritization procedure, which may result the value of the Buffer Size field to zero). The amount of data is indicated in number of bytes. The size of the RLC and MAC headers are not considered in the buffer size computation. The length of this field for the Short BSR format and the Short Truncated BSR format is 5 bits. The length of this field for the Long BSR format and the Long Truncated BSR format is 8 bits. The values for the 5-bit and 8-bit Buffer Size fields are shown in Tables 6.1.3.1-1 and 6.1.3.1-2, respectively. For the Long BSR format and the Long Truncated BSR format, the Buffer Size fields are included in ascending order based on the LCGᵢ. For the Long Truncated BSR format the number of Buffer Size fields included is maximised, while not exceeding the number of padding bits. For the Pre-emptive BSR, the Buffer Size field identifies the total amount of the data expected to arrive at the IAB-MT of the node where the Pre-emptive BSR is triggered. Pre-emptive BSR is identical to the Long BSR format.
NOTE 1: For the Pre-emptive BSR, if configured, the LCGs to be reported, the expected data volume calculation, the exact time to report Pre-emptive BSR and the associated LCH are left to implementation.
NOTE 2: The mapping of LCGs between the ingress and egress links of an IAB node for purposes of determining expected change in occupancy of IAB-MT buffers (to be reported as Pre-emptive BSR) is left to implementation.
NOTE 3: The number of the Buffer Size fields in the Long BSR and Long Truncated BSR format can be zero.

As described in clause 5.6 in 3GPP TS 38.323 V16.0.0, for the purpose of MAC buffer status reporting, the transmitting packet data convergence protocol (PDCP) entity shall consider the following as PDCP data volume: the PDCP service data units (SDUs) for which no PDCP Data protocol data units (PDUs) have been constructed; the PDCP Data PDUs that have not been submitted to lower layers; the PDCP Control PDUs; for acknowledged mode (AM) data radio bearers (DRBs), the PDCP SDUs to be retransmitted according to clause 5.1.2; for AM DRBs, the PDCP Data PDUs to be retransmitted according to clause 5.5.

Further details from 3GPP TS 38.323 V16.0.0 clause 5.6 are as follows:

If the transmitting PDCP entity is associated with at least two RLC entities, when indicating the PDCP data volume to a MAC entity for BSR triggering and Buffer Size calculation (as specified in TS 38.321 and TS 36.321), the transmitting PDCP entity shall:
if the PDCP duplication is activated:
   indicate the PDCP data volume to the MAC entity associated with the primary RLC entity;
   indicate the PDCP data volume excluding the PDCP Control PDU to the MAC entity associated with the RLC entity other than the primary RLC entity activated for PDCP duplication;
   indicate the PDCP data volume as 0 to the MAC entity associated with RLC entity deactivated for PDCP duplication;
else:
   if the split secondary RLC entity is configured; and
   if the transmitting PDCP entity is not associated with a DAPS bearer; and
   if the total amount of PDCP data volume and RLC data volume pending for initial transmission (as specified in TS 38.322) in the primary RLC entity and the split secondary RLC entity is equal to or larger than ul-DataSplitThreshold:
      indicate the PDCP data volume to both the MAC entity associated with the primary RLC entity and the MAC entity associated with the split secondary RLC entity;
      indicate the PDCP data volume as 0 to the MAC entity associated with RLC entity other than the primary RLC entity and the split secondary RLC entity;
   else, if the transmitting PDCP entity is associated with the DAPS bearer:
      if the uplink data switching has not been requested:
         indicate the PDCP data volume to the MAC entity associated with the source cell;
      else:
         indicate the PDCP data volume excluding the PDCP Control PDU for interspersed ROHC feedback associated with the source cell to the MAC entity associated with the target cell;
         indicate the PDCP data volume of PDCP Control PDU for interspersed ROHC feedback associated with the source cell to the MAC entity associated with the source cell;
   else:
      indicate the PDCP data volume to the MAC entity associated with the primary RLC entity;
      indicate the PDCP data volume as 0 to the MAC entity associated with the RLC entity other than the primary RLC entity.

As described in clause 5.5 in 3GPP TS 38.322 V16.0.0, for the purpose of MAC buffer status reporting, the UE shall consider the following as radio link control (RLC) data volume: RLC SDUs and RLC SDU segments that have not yet been included in an RLC data PDU; RLC data PDUs that are pending for initial transmission; RLC data PDUs that are pending for retransmission (RLC AM). In addition, if a STATUS PDU has been triggered and t-StatusProhibit is not running or has expired, the UE shall estimate the size of the STATUS PDU that will be transmitted in the next transmission opportunity, and consider this as part of RLC data volume.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for resource allocation to terminal device. In particular, one of the problems to be solved by the disclosure is that the base station may not be able to assign grants to a UE-to-network relay in good time in the existing solution.

According to a first aspect of the disclosure, there is provided a method performed by a first terminal device. The first terminal device connects to a network via a second terminal device acting as a relay therebetween. The method comprises transmitting, to the second terminal device, a report message comprising at least information related to a volume of data from the first terminal device to the second terminal device.

In this way, it is possible to reduce latency for data transmissions, especially delay sensitive transmissions.

In an embodiment of the disclosure, the volume of the data from the first terminal device to the second terminal device may comprise a data volume which needs to be relayed by the second terminal device to the network.

In an embodiment of the disclosure, the data from the first terminal device to the second terminal device may comprise at least one of: data to be transmitted from the first terminal device to the second terminal device; and data being transmitted from the first terminal device to the second terminal device.

In an embodiment of the disclosure, the information related to the volume of the data from the first terminal device to the second terminal device may comprise at least one of: a buffer size for every logical channel group (LCG) or logical channel (LCH); buffer sizes for one or more LCGs or LCHs with data available; and a summarized buffer size for all LCGs or LCHs.

In an embodiment of the disclosure, the buffer size may comprise at least one of: a buffer size at a radio link control (RLC) layer; and a buffer size at a packet data convergence protocol (PDCP) layer.

In an embodiment of the disclosure, the report message may further comprise at least one of following information: a source terminal device identity (ID) for every LCG or LCH; source terminal device IDs for one or more LCGs or LCHs with data available; a destination terminal device ID for every LCG or LCH; destination terminal device IDs for one or more LCGs or LCHs with data available; a first indicator indicating whether the report message can be decoded by the second terminal device; a second indicator indicating whether the report message needs to be relayed to the network; and timing information indicating a time when the data can be received by the second terminal device.

In an embodiment of the disclosure, the report message may be one of: a radio resource control (RRC) message; a buffer status report (BSR); a message in an adaptation layer; an RLC message; a PDCP message; and a service data adaptation protocol (SDAP) message.

In an embodiment of the disclosure, the RRC message may be a PC5-RRC message, and/or the RLC message may be a PC5-RLC message.

In an embodiment of the disclosure, the information included in the report message may be carried by one of: a Uu RRC message contained in a container included in the PC5-RRC message; a PC5-RRC signaling information element included in the PC5-RRC message; a media access control (MAC) control element (CE) of the BSR; an MAC subheader of the BSR; a control protocol data unit (PDU) of the adaptation layer; a control PDU of the RLC layer; a control PDU of the PDCP layer; and a control PDU of the SDAP layer.

In an embodiment of the disclosure, the BSR may be a sidelink BSR or a Uu BSR.

According to a second aspect of the disclosure, there is provided a method performed by a second terminal device. The second terminal device acts as a relay between a first terminal device and a network. The method comprises receiving, from the first terminal device, a report message comprising at least information related to a volume of data from the first terminal device to the second terminal device. The method further comprises transmitting, to a base station, the information related to the volume without decoding the information related to the volume.

In this way, it is possible to reduce latency for data transmissions, especially delay sensitive transmissions.

In an embodiment of the disclosure, the transmitting of the information related to the volume may be performed according to at least one of: a first indicator included in the report message indicating that the report message cannot be decoded by the second terminal device; a second indicator included in the report message indicating that the report message needs to be relayed to the network; a signaling from the base station indicating that the report message cannot be decoded by the second terminal device; and a preconfiguration in the second terminal device.

In an embodiment of the disclosure, the signaling may be one of: an RRC signaling; a downlink control information (DCI); and an MAC CE.

In an embodiment of the disclosure, the information related to the volume may be transmitted in one of: an RRC message; and a BSR.

In an embodiment of the disclosure, the RRC message may be a Uu RRC message, and/or the BSR may be a sidelink BSR.

In an embodiment of the disclosure, the method may further comprise providing user data. The method may further comprise forwarding the user data to a host computer via the transmission to the base station.

According to a third aspect of the disclosure, there is provided a method performed by a second terminal device. The second terminal device acts as a relay between a first terminal device and a network. The method comprises receiving, from the first terminal device, a report message comprising at least information related to a first volume of data from the first terminal device to the second terminal device. The method further comprises determining a BSR based on the report message such that the BSR comprises at least one of: information related to at least part of the first volume which needs to be relayed by the second terminal device to the network; and information related to a second volume of data of the second terminal device. The method further comprises transmitting the BSR to a base station.

In this way, it is possible to reduce latency for data transmissions, especially delay sensitive transmissions. In a case where the information related to the at least part of the first volume is included in the BSR, a pre-emptive (or early) BSR can be introduced such that the base station is able to provide a grant to the second terminal device for its cellular link in advance of the data being received from the first terminal device.

In an embodiment of the disclosure, the method may further comprise transmitting the information related to the at least part of the first volume to the base station.

In an embodiment of the disclosure, the report message may further comprise timing information indicating a time when the data can be received by the second terminal device from the first terminal device. The method may further comprise transmitting the timing information to the base station.

In an embodiment of the disclosure, the determining and transmitting of the BSR may be performed according to at least one of: a first indicator included in the report message indicating that the report message can be decoded by the second terminal device; a second indicator included in the report message indicating that the report message needs to be relayed to the network; a signaling from the base station indicating that the report message can be decoded by the second terminal device; and a preconfiguration in the second terminal device.

In an embodiment of the disclosure, the signaling may be one of: an RRC signaling; a DCI; and an MAC CE.

In an embodiment of the disclosure, the information related to the at least part of the first volume included in the BSR may comprise information related to a volume of data to be received from the first terminal device. When the second terminal device actually receives the data from the first terminal device, the volume of the data may be included again in another BSR sent by the second terminal device to the base station.

In an embodiment of the disclosure, the information related to the at least part of the first volume included in the BSR may comprise information related to a volume of data to be received from the first terminal device. When the second terminal device actually receives the data from the first terminal device, the volume of the data may not be included again in another BSR sent by the second terminal device to the base station.

In an embodiment of the disclosure, the second terminal device may act as a relay between multiple first terminal devices and the network. More than one report message may be received from more than one of the multiple first terminal devices.

In an embodiment of the disclosure, the information related to the at least part of the first volumes corresponding to the more than one first terminal device may comprise one of: summarized buffer sizes of the more than one first terminal device; and a summarized buffer size for every LCG or LCH corresponding to the more than one first terminal device.

In an embodiment of the disclosure, the information included in the BSR may be sent in more than two BSR MAC CEs contained in a same MAC PDU.

In an embodiment of the disclosure, the method may further comprise providing user data. The method may further comprise forwarding the user data to a host computer via the transmission to the base station.

According to a fourth aspect of the disclosure, there is provided a method performed by a base station. The method comprises receiving, from a second terminal device acting as a relay between a first terminal device and a network, information related to a volume of data from the first terminal device to the second terminal device on a link between the first and second terminal device. The method further comprises assigning a transmission grant to the link between the first and second terminal device based on the information.

In this way, it is possible to reduce latency for data transmissions, especially delay sensitive transmissions.

According to a fifth aspect of the disclosure, there is provided a method performed by a base station. The method comprises receiving, from a second terminal device acting as a relay between a first terminal device and a network, a BSR comprising at least one of: information related to at least part of a first volume of data from the first terminal device which needs to be relayed by the second terminal device to the network; and information related to a second volume of data of the second terminal device. The method further comprises assigning an uplink transmission grant to the second terminal device based on the BSR.

In this way, it is possible to reduce latency for data transmissions, especially delay sensitive transmissions. In a case where the information related to the at least part of the first volume is included in the BSR, a pre-emptive (or early) BSR can be introduced such that the base station is able to provide a grant to the second terminal device for its cellular link in advance of the data being received from the first terminal device.

In an embodiment of the disclosure, the method may further comprise receiving, from the second terminal device, information related to the at least part of the first volume on a link between the first and second terminal device. The method may further comprise assigning a transmission grant to the link between the first and second terminal device based on the information.

In an embodiment of the disclosure, the method may further comprise receiving, from the second terminal device, timing information indicating a time when the data can be received by the second terminal device from the first terminal device. The uplink transmission grant may be assigned based further on the timing information.

In an embodiment of the disclosure, the method may further comprise sending, to the second terminal device, a signaling indicating whether a report message sent from the first terminal device to the second terminal device can be decoded by the second terminal device. The report message may comprise at least information related to a volume of data from the first terminal device.

According to a sixth aspect of the disclosure, there is provided a first terminal device. The first terminal device connects to a network via a second terminal device acting as a relay therebetween. The first terminal device comprises at least one processor and at least one memory. The at least one memory contains instructions executable by the at least one processor, whereby the first terminal device is operative to transmit, to the second terminal device, a report message comprising at least information related to a volume of data from the first terminal device to the second terminal device.

In an embodiment of the disclosure, the first terminal device may be operative to perform the method according to the above first aspect.

According to a seventh aspect of the disclosure, there is provided a second terminal device. The second terminal device acts as a relay between a first terminal device and a network. The second terminal device comprises at least one processor and at least one memory. The at least one memory contains instructions executable by the at least one processor, whereby the second terminal device is operative to receive, from the first terminal device, a report message comprising at least information related to a volume of data from the first terminal device to the second terminal device. The second terminal device is further operative to transmit, to a base station, the information related to the volume without decoding the information related to the volume.

In an embodiment of the disclosure, the second terminal device may be operative to perform the method according to the above second aspect.

According to an eighth aspect of the disclosure, there is provided a second terminal device. The second terminal device acts as a relay between a first terminal device and a network. The second terminal device comprises at least one processor and at least one memory. The at least one memory contains instructions executable by the at least one processor, whereby the second terminal device is operative to receive, from the first terminal device, a report message comprising at least information related to a first volume of data from the first terminal device to the second terminal device. The second terminal device is further operative to determine a BSR based on the report message such that the BSR comprises at least one of: information related to at least part of the first volume which needs to be relayed by the second terminal device to the network; and information related to a second volume of data of the second terminal device. The second terminal device is further operative to transmit the BSR to a base station.

In an embodiment of the disclosure, the second terminal device may be operative to perform the method according to the above third aspect.

According to a ninth aspect of the disclosure, there is provided a base station. The base station comprises at least one processor and at least one memory. The at least one memory contains instructions executable by the at least one processor, whereby the base station is operative to receive, from a second terminal device acting as a relay between a first terminal device and a network, information related to a volume of data from the first terminal device to the second terminal device on a link between the first and second terminal device. The base station is further operative to assign a transmission grant to the link between the first and second terminal device based on the information.

According to a tenth aspect of the disclosure, there is provided a base station. The base station comprises at least one processor and at least one memory. The at least one memory contains instructions executable by the at least one processor, whereby the base station is operative to receive, from a second terminal device acting as a relay between a first terminal device and a network, a BSR comprising at least one of: information related to at least part of a first volume of data from the first terminal device which needs to be relayed by the second terminal device to the network; and information related to a second volume of data of the second terminal device. The base station is further operative to assign an uplink transmission grant to the second terminal device based on the BSR.

In an embodiment of the disclosure, the base station may be operative to perform the method according to the above fifth aspect.

According to an eleventh aspect of the disclosure, there is provided a computer program product. The computer program product comprises instructions which when executed by at least one processor, cause the at least one processor to perform the method according to any of the above first to fifth aspects.

According to a twelfth aspect of the disclosure, there is provided a computer readable storage medium. The computer readable storage medium comprises instructions which when executed by at least one processor, cause the at least one processor to perform the method according to any of the above first to fifth aspects.

According to a thirteenth aspect of the disclosure, there is provided a first terminal device. The first terminal device connects to a network via a second terminal device acting as a relay therebetween. The first terminal device comprises a transmission module for transmitting, to the second terminal device, a report message comprising at least information related to a volume of data from the first terminal device to the second terminal device.

According to a fourteenth aspect of the disclosure, there is provided a second terminal device. The second terminal device acts as a relay between a first terminal device and a network. The second terminal device comprises a reception module for receiving, from the first terminal device, a report message comprising at least information related to a volume of data from the first terminal device to the second terminal device. The second terminal device further comprises a transmission module for transmitting, to a base station, the information related to the volume without decoding the information related to the volume.

According to a fifteenth aspect of the disclosure, there is provided a second terminal device. The second terminal device acts as a relay between a first terminal device and a network. The second terminal device comprises a reception module for receiving, from the first terminal device, a report message comprising at least information related to a first volume of data from the first terminal device to the second terminal device. The second terminal device further comprises a determination module for determining a BSR based on the report message such that the BSR comprises at least one of: information related to at least part of the first volume which needs to be relayed by the second terminal device to the network; and information related to a second volume of data of the second terminal device. The second terminal device further comprises a transmission module for transmitting the BSR to a base station.

According to a sixteenth aspect of the disclosure, there is provided a base station. The base station comprises a reception module for receiving, from a second terminal device acting as a relay between a first terminal device and a network, information related to a volume of data from the first terminal device to the second terminal device on a link between the first and second terminal device. The base station further comprises an assigning module for assigning a transmission grant to the link between the first and second terminal device based on the information.

According to a seventeenth aspect of the disclosure, there is provided a base station. The base station comprises a reception module for receiving, from a second terminal device acting as a relay between a first terminal device and a network, a BSR comprising at least one of: information related to at least part of a first volume of data from the first terminal device which needs to be relayed by the second terminal device to the network; and information related to a second volume of data of the second terminal device. The base station further comprises an assigning module for assigning an uplink transmission grant to the second terminal device based on the BSR.

According to an eighteenth aspect of the disclosure, there is provided a method implemented in a communication system including a first terminal device, a second terminal device and a base station. The method comprises steps of the methods according to the above first, second and fourth aspects.

According to a nineteenth aspect of the disclosure, there is provided a method implemented in a communication system including a first terminal device, a second terminal device and a base station. The method comprises steps of the methods according to the above first, third and fifth aspects.

According to a twentieth aspect of the disclosure, there is provided a communication system including a first terminal device according to the above sixth or thirteenth aspect, a second terminal device according to the above seventh or fourteenth aspect and a base station according to the above ninth or sixteenth aspect.

According to a twenty-first aspect of the disclosure, there is provided a communication system including a first terminal device according to the above sixth or thirteenth aspect, a second terminal device according to the above eighth or fifteenth aspect and a base station according to the above tenth or seventeenth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating the physical resource grid of NR;

FIG. 2 is a diagram illustrating short BSR and short truncated BSR MAC CE;

FIG. 3 is a diagram illustrating long BSR, long truncated BSR, and pre-emptive BSR MAC CE;

FIG. 4 is a diagram illustrating SL-BSR and truncated SL-BSR MAC CE;

FIG. 5 is a diagram illustrating the architecture model using a ProSe UE-to-Network Relay;

FIG. 6 is a diagram illustrating the protocol stack for ProSe UE-to-Network Relay;

FIG. 7 is a flowchart illustrating a process involving ProSe UE-to-Network Relay;

FIG. 8 is a diagram illustrating the user plane stack for L2 UE-to-Network Relay UE;

FIG. 9 is a diagram illustrating the control plane for L2 UE-to-Network Relay UE;

FIG. 10 is a flowchart illustrating connection establishment for indirect communication via UE-to-Network Relay UE;

FIG. 11 is a diagram illustrating an embodiment of the disclosure;

FIG. 12 is a diagram illustrating another embodiment of the disclosure;

FIG. 13 is a flowchart illustrating a method performed by a first terminal device according to an embodiment of the disclosure;

FIG. 14 is a flowchart illustrating a method performed by a second terminal device according to an embodiment of the disclosure;

FIG. 15 is a flowchart illustrating a method performed by a second terminal device according to an embodiment of the disclosure;

FIG. 16 is a flowchart illustrating a method performed by a second terminal device according to an embodiment of the disclosure;

FIG. 17 is a flowchart illustrating a method performed by a base station according to an embodiment of the disclosure;

FIG. 18 is a flowchart illustrating a method performed by a base station according to an embodiment of the disclosure;

FIG. 19 is a flowchart illustrating a method performed by a base station according to an embodiment of the disclosure;

FIG. 20 is a block diagram showing an apparatus suitable for use in practicing some embodiments of the disclosure;

FIG. 21 is a block diagram showing a first terminal device according to an embodiment of the disclosure;

FIG. 22 is a block diagram showing a second terminal device according to an embodiment of the disclosure;

FIG. 23 is a block diagram showing a second terminal device according to an embodiment of the disclosure;

FIG. 24 is a block diagram showing a base station according to an embodiment of the disclosure;

FIG. 25 is a block diagram showing a base station according to an embodiment of the disclosure;

FIG. 26 is a diagram showing a telecommunication network connected via an intermediate network to a host computer in accordance with some embodiments;

FIG. 27 is a diagram showing a host computer communicating via a base station with a user equipment in accordance with some embodiments;

FIG. 28 is a flowchart illustrating a method implemented in a communication system in accordance with some embodiments;

FIG. 29 is a flowchart illustrating a method implemented in a communication system in accordance with some embodiments;

FIG. 30 is a flowchart illustrating a method implemented in a communication system in accordance with some embodiments; and

FIG. 31 is a flowchart illustrating a method implemented in a communication system in accordance with some embodiments.

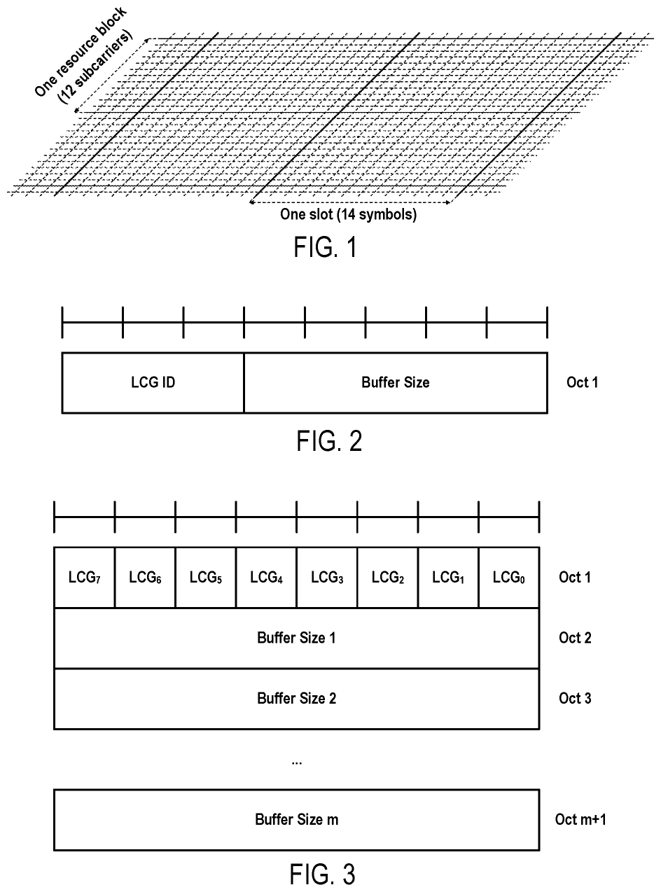

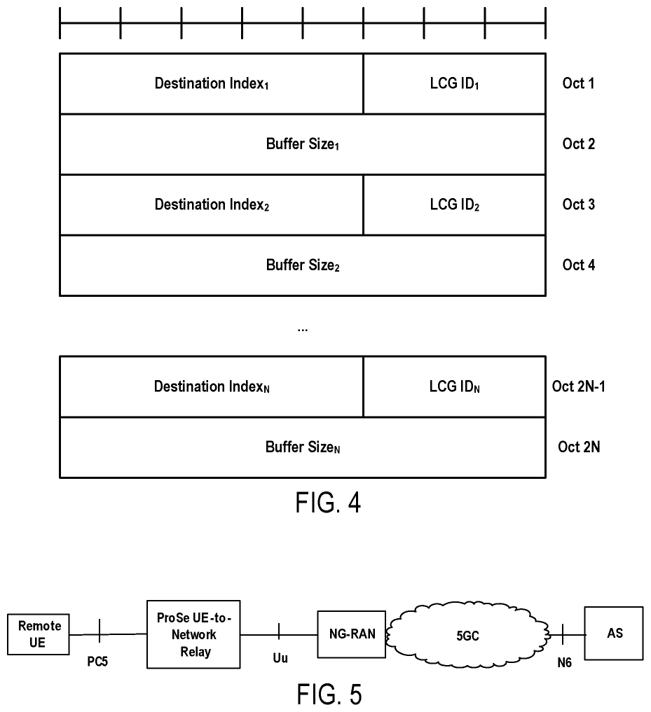

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The term “base station (BS)” may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth. A base station may comprise a central unit (CU) and one or more distributed units (DU). The CU and DU(s) may co-locate in a same network node, e.g. a same base station.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

Sidelink transmissions over NR are specified for release 16 (Rel. 16). These are enhancements of the proximity-based services (ProSe) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the quality of service (QoS) management is supported in NR sidelink transmissions.

To enable the above enhancements, new physical channels and reference signals are introduced in NR (available in LTE before):
Physical sidelink shared channel (PSSCH, sidelink (SL) version of PDSCH): The PSSCH is transmitted by a sidelink transmitter UE, which conveys sidelink transmission data, system information blocks (SIBs) for RRC configuration, and a part of the sidelink control information (SCI).
Physical sidelink feedback channel (PSFCH, SL version of physical uplink control channel (PUCCH)): The PSFCH is transmitted by a sidelink receiver UE for unicast and groupcast, which conveys 1 bit information over 1 RB for the hybrid automatic repeat request (HARQ) acknowledgement (ACK) and the negative ACK (NACK). In addition, channel state information (CSI) is carried in the MAC CE over the PSSCH instead of the PSFCH.
Physical sidelink common control channel (PSCCH, SL version of PDCCH): When the traffic to be sent to a receiver UE arrives at a transmitter UE, a transmitter UE should first send the PSCCH, which conveys a part of sidelink control information (SCI, SL version of DCI) to be decoded by any UE for the channel sensing purpose, including the reserved time-frequency resources for transmissions, demodulation reference signal (DMRS) pattern and antenna port, etc.
Sidelink primary/secondary synchronization signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter sending the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical sidelink broadcast channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for frequency range 2 (FR2) transmission.

Another new feature is the two-stage sidelink control information (SCI). This is a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, new data indicator (NDI), redundancy version (RV) and HARQ process ID is sent on the PSSCH to be decoded by the receiver UE.

Similar as for PRoSE in LTE, NR sidelink transmissions have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.
   For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2. Mode 1 supports the following two kinds of grants:
Dynamic grant: When the traffic to be sent over sidelink arrives at a transmitter UE, this UE should launch the four-message exchange procedure to request sidelink resources from a gNB (scheduling request (SR) on UL, grant, buffer status report (BSR) on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with cyclic redundancy check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI. When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring reference signal receiving power (RSRP) on different subchannels and requires knowledge of the different UEs power levels of DMRS on the PSSCH or the DMRS on the PSCCH depending on the configuration. This information is known only after receiver SCI is launched by (all) other UEs. The sensing and selection algorithm is rather complex.

There are device-to-device (D2D) discovery procedures for detection of services and applications offered by other UEs in close proximity. This is part of LTE Rel 12 and Rel 13. The discovery procedure has two modes, mode A based on open announcements (broadcasts) and mode B, which is request/response. The discovery mechanism is controlled by the application layer (ProSe). The discovery message is sent on the physical sidelink discovery channel (PSDCH) which is not available in NR. Also, there is a specific resource pool for announcement and monitoring of discovery messages. The discovery procedure can be used to detect UEs supporting certain services or applications before initiating direct communication.

As described in clause 5.22.1.6 in 3GPP TS 38.321 V16.0.0, the sidelink buffer status reporting (SL-BSR) procedure is used to provide the serving gNB with information about SL data volume in the MAC entity. RRC configures the following parameters to control the SL-BSR:
periodicBSR-Timer;
retxBSR-Timer;
sl-logicalChannelSR-DelayTimerApplied;
logicalChannelSR-DelayTimer;
sl-logicalChannelGroup.

Further details from clause 5.22.1.6 in 3GPP TS 38.321 V16.0.0 are as follows:

Each logical channel which belongs to a Destination is allocated to an LCG as specified in TS 38.331 or TS 36.331. The maximum number of LCGs is eight.
The MAC entity determines the amount of SL data available for a logical channel according to the data volume calculation procedure in TSs 38.322 and 38.323.
A SL-BSR shall be triggered if any of the following events occur:
1> if the MAC entity has a SL-RNTI or SLCS-RNTI:
   2> SL data, for a logical channel of a Destination, becomes available to the MAC entity; and either
      3> this SL data belongs to a logical channel with higher priority than the priorities of the logical channels containing available SL data which belong to any LCG belonging to the same Destination; or
      3> none of the logical channels which belong to an LCG belonging to the same Destination contains any available SL data.
      in which case the SL-BSR is referred below to as ‘Regular SL-BSR’;
   2> UL resources are allocated and number of padding bits remaining after a Padding BSR has been triggered is equal to or larger than the size of the SL-BSR MAC CE plus its subheader, in which case the SL-BSR is referred below to as ‘Padding SL-BSR’;
   2> retxBSR-Timer expires, and at least one of the logical channels which belong to an LCG contains SL data, in which case the SL-BSR is referred below to as ‘Regular SL-BSR’;
   2> periodicBSR-Timer expires, in which case the SL-BSR is referred below to as ‘Periodic SL-BSR’.
1> else:
   2> An SL-RNTI is configured by RRC and SL data is available for transmission in the RLC entity or in the PDCP entity, in which case the Sidelink BSR is referred below to as “Regular Sidelink BSR”.
      For Regular SL-BSR, the MAC entity shall:
1> if the SL-BSR is triggered for a logical channel for which sl-logicalChannelSR-DelayTimerApplied with value true is configured by upper layers:
   2> start or restart the logicalChannelSR-DelayTimer.
1> else:
   2> if running, stop the logicalChannelSR-DelayTimer.
      For Regular and Periodic SL-BSR, the MAC entity shall:
1> if sl-P rioritizationThres is configured and the value of the highest priority of the logical channels that belong to any LCG and contain SL data for any Destination is lower than sl-PrioritizationThres; and
1> if either ul-P rioritizationThres is not configured or ul-P rioritizationThres is configured and the value of the highest priority of the logical channels that belong to any LCG and contain UL data is equal to or higher than ul-P rioritizationThres according to clause 5.4.5 in TS 38.321:
   2> prioritize the LCG(s) for the Destination(s).
1> if the Buffer Status reporting procedure determines that at least one BSR has been triggered and not cancelled according to clause 5.4.5 and the UL grant cannot accommodate a SL-BSR MAC CE containing buffer status only for all prioritized LCGs having data available for transmission plus the subheader of the SL-BSR according to clause 5.4.3.1.3 in TS 38.321, in case the SL-BSR is considered as not prioritized:
   3> report Truncated SL-BSR containing buffer status for as many prioritized LCGs having data available for transmission as possible, taking the number of bits in the UL grant into consideration;
      3> prioritize the SL-BSR for logical channel prioritization specified in clause 5.4.3.1 in TS 38.321.
1> else if the number of bits in the UL grant is expected to be equal to or larger than the size of a SL-BSR containing buffer status for all LCGs having data available for transmission plus the subheader of the SL-BSR according to clause 5.4.3.1.3 in TS 38.321:
   2> report SL-BSR containing buffer status for all LCGs having data available for transmission.
1> else:
   2> report Truncated SL-BSR containing buffer status for as many LCGs having data available for transmission as possible, taking the number of bits in the UL grant into consideration.

### For Padding BSR:

1> if the number of padding bits remaining after a Padding BSR has been triggered is equal to or larger than the size of a SL-BSR containing buffer status for all LCGs having data available for transmission plus its subheader:
   2> report SL-BSR containing buffer status for all LCGs having data available for transmission;
1> else:
   2> report Truncated SL-BSR containing buffer status for as many LCGs having data available for transmission as possible, taking the number of bits in the UL grant into consideration.
      For SL-BSR triggered by retxBSR-Timer expiry, the MAC entity considers that the logical channel that triggered the SL-BSR is the highest priority logical channel that has data available for transmission at the time the SL-BSR is triggered.
      The MAC entity shall:
1> if the sidelink Buffer Status reporting procedure determines that at least one SL-BSR has been triggered and not cancelled:
   2> if UL-SCH resources are available for a new transmission and the UL-SCH resources can accommodate the SL-BSR MAC CE plus its subheader as a result of logical channel prioritization according to clause 5.4.3.1 in TS 38.321:
      3> instruct the Multiplexing and Assembly procedure in clause 5.4.3 in TS 38.321 to generate the SL-BSR MAC CE(s);
      3> start or restart periodicBSR-Timer except when all the generated SL-BSRs are Truncated SL-BSRs;
      3> start or restart retxBSR-Timer.
   2> if a Regular SL-BSR has been triggered and logicalChannelSR-DelayTimer is not running:
      3> if there is no UL-SCH resource available for a new transmission:
         4> trigger a Scheduling Request.
NOTE 1: UL-SCH resources are considered available if the MAC entity has an active configuration for either type of configured uplink grants, or if the MAC entity has received a dynamic uplink grant, or if both of these conditions are met. If the MAC entity has determined at a given point in time that UL-SCH resources are available, this need not imply that UL-SCH resources are available for use at that point in time.
   A MAC PDU shall contain at most one SL-BSR MAC CE, even when multiple events have triggered a SL-BSR. The Regular SL-BSR and the Periodic SL-BSR shall have precedence over the padding SL-BSR.
   The MAC entity shall restart retxBSR-Timer upon reception of an SL grant for transmission of new data on any SL-SCH.
   All triggered SL-BSRs may be cancelled when the SL grant(s) can accommodate all pending data available for transmission. All BSRs triggered prior to MAC PDU assembly shall be cancelled when a MAC PDU is transmitted and this PDU includes a SL-BSR MAC CE which contains buffer status up to (and including) the last event that triggered a SL-BSR prior to the MAC PDU assembly. All triggered SL-BSRs shall be cancelled, and retx-BSR-Timer and periodic-BSR-Timer shall be stopped, when RRC configures autonomous resource selection.
NOTE 2: MAC PDU assembly can happen at any point in time between uplink grant reception and actual transmission of the corresponding MAC PDU. SL-BSR and SR can be triggered after the assembly of a MAC PDU which contains a SL-BSR MAC CE, but before the transmission of this MAC PDU. In addition, SL-BSR and SR can be triggered during MAC PDU assembly.

As described in clause 6.1.3.33 in 3GPP TS 38.321 V16.0.0, sidelink buffer status report (SL-BSR) MAC CEs consist of either: SL-BSR format (variable size); or Truncated SL-BSR format (variable size).

Further details from clause 6.1.3.33 in 3GPP TS 38.321 V16.0.0 are as follows:

SL-BSR and Truncated SL-BSR MAC control elements consist of one Destination Index field, one LCG ID field and one corresponding Buffer Size field per reported target group.
The SL-BSR formats are identified by MAC subheaders with LCIDs as specified in in Table 6.2.1-2.
The fields in the SL-BSR MAC CE are defined as follows:
Destination Index: The Destination Index field identifies the destination. The length of this field is 5 bits. The value is set to one index among index(es) associated to same destination reported in [v2x-DestinationInfoList]. If multiple such lists are reported, the value is indexed sequentially across all the lists in the same order as specified in TS 38.331;
LCG ID: The Logical Channel Group ID field identifies the group of logical channel(s) whose SL buffer status is being reported. The length of the field is 3 bits;
Buffer Size: The Buffer Size field identifies the total amount of data available according to the SL data volume calculation procedure in TSs 38.322 and 38.323 across all logical channels of a logical channel group of a destination after the MAC PDU has been built (i.e. after the logical channel prioritization procedure, which may result the value of the Buffer Size field to zero). The amount of data is indicated in number of bytes. The size of the RLC and MAC headers are not considered in the buffer size computation. The length of this field is 8 bits. The values for the Buffer Size field are shown in Table 6.1.3.1-2, respectively. For the SL-BSR format and the Truncated SL-BSR format, the Buffer Size fields are included in ascending order based on the LCGᵢ. For the Truncated SL-BSR format the number of Buffer Size fields included is maximised, while not exceeding the number of padding bits.
NOTE: The number of the Buffer Size fields in the SL-BSR and Truncated SL-BSR format can be zero.

In the 3GPP technical report (TR) 23.752 v0.3.0 clause 6.6, the layer-3 based UE-to-Network relay is described as below.

The ProSe 5G UE-to-Network Relay entity provides the functionality to support connectivity to the network for Remote UEs (see FIG. 2). It can be used for both public safety services and commercial services (e.g. interactive service).
A UE is considered to be a Remote UE for a certain ProSe UE-to-Network relay if it has successfully established a PC5 link to this ProSe 5G UE-to-Network Relay. A Remote UE can be located within NG-RAN coverage or outside of NG-RAN coverage.
The ProSe 5G UE-to-Network Relay shall relay unicast traffic (UL and DL) between the Remote UE and the network. The ProSe UE-to-Network Relay shall provide generic function that can relay any IP traffic.
One-to-one Direct Communication is used between Remote UEs and ProSe 5G UE-to-Network Relays for unicast traffic as specified in solutions for Key Issue #2 in the TR 23.752 v0.3.0.
The protocol stack for Layer-3 UE-to-Network Relays is shown in FIG. 3.
Hop-by-hop security is supported in the PC5 link and Uu link. If there are requirements beyond hop-by-hop security for protection of Remote UE's traffic, security over IP layer needs to be applied.
Further security details (integrity and privacy protection for remote UE-Nw communication) will be specified in SA WG3.
A ProSe 5G UE-to-Network Relay capable UE may register to the network (if not already registered) and establish a PDU session enabling the necessary relay traffic, or it may need to connect to additional PDU session(s) or modify the existing PDU session in order to provide relay traffic towards Remote UE(s). PDU session(s) supporting UE-to-Network Relay shall only be used for Remote ProSe UE(s) relay traffic.

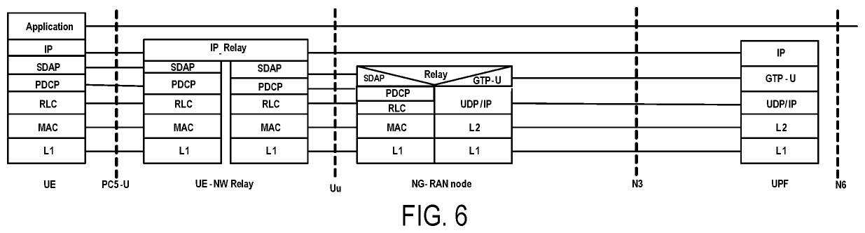

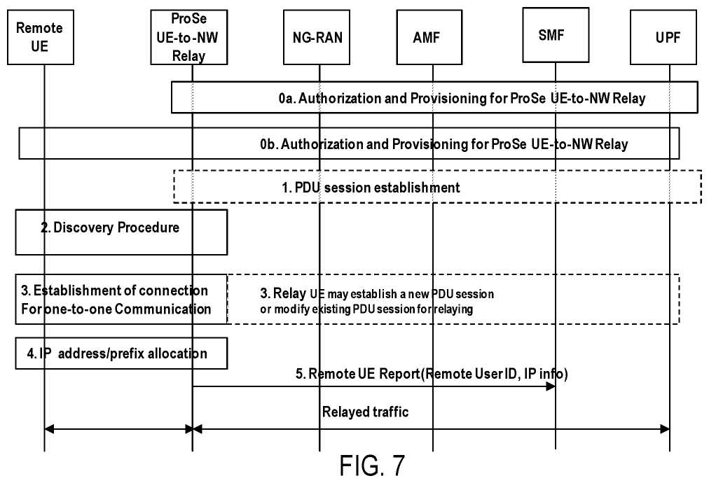

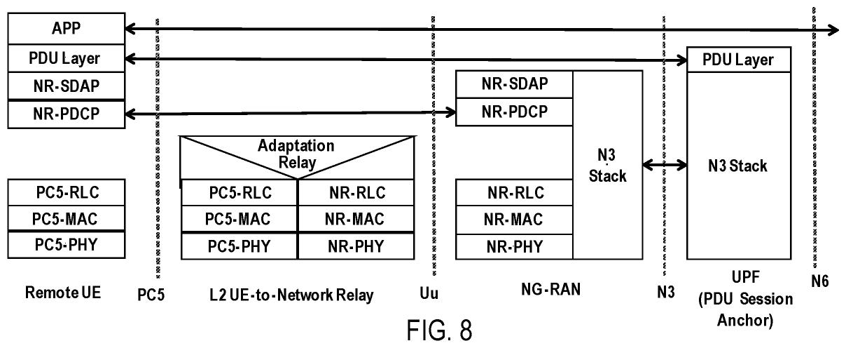

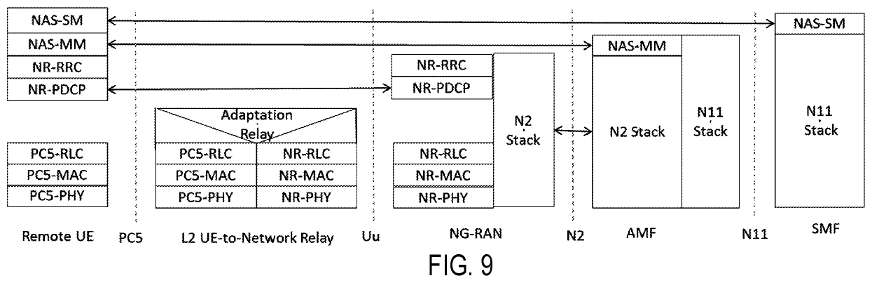

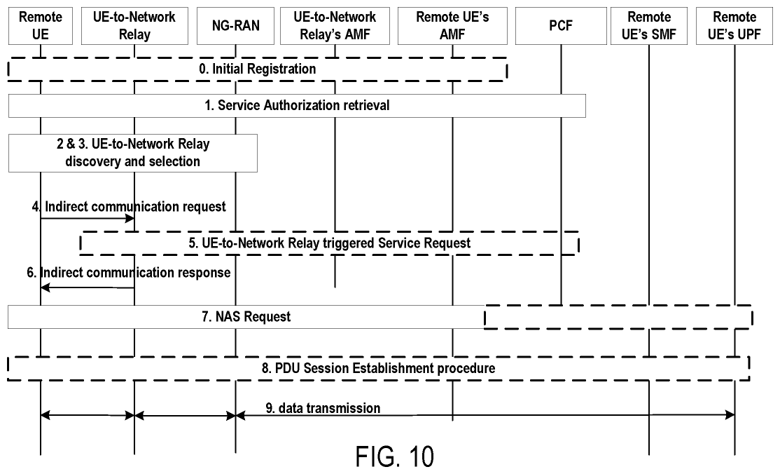

### FIG. 6.6.2-1: ProSe 5G UE-to-Network Relay in TR 23.752

0. During the Registration procedure, Authorization and provisioning is performed for the ProSe UE-to-NW relay and Remote UE. Authorization and provisioning procedure may be any solution for key issue #1 and #3 in the TR 23.752 v0.3.0.
1. The ProSe 5G UE-to-Network Relay may establish a PDU session for relaying with default PDU session parameters received in step 0 or pre-configured in the UE-to-NW relay, e.g. S-NSSAI, DNN, SSC mode. In case of IPv6, the ProSe UE-to-Network Relay obtains the IPv6 prefix via prefix delegation function from the network as defined in TS 23.501.
2. Based on the Authorization and provisioning in step 0, the Remote UE performs discovery of a ProSe 5G UE-to-Network Relay using any solution for key issue #1 and #3 in the TR 23.752 v0.3.0. As part of the discovery procedure the Remote UE learns about the connectivity service the ProSe UE-to-Network Relay provides.
3. The Remote UE selects a ProSe 5G UE-to-Network Relay and establishes a connection for One-to-one ProSe Direct Communication as described in TS 23.287.
   If there is no PDU session satisfying the requirements of the PC5 connection with the remote UE, e.g. S-NSSAI, DNN, QoS, the ProSe 5G UE-to-Network Relay initiates a new PDU session establishment or modification procedure for relaying.
4. IPv6 prefix or IPv4 address is allocated for the remote UE as it is defined in TS 23.303 clauses 5.4.4.2 and 5.4.4.3. From this point the uplink and downlink relaying can start.
5. The ProSe 5G UE-to-Network Relay sends a Remote UE Report (Remote User ID, IP info) message to the SMF for the PDU session associated with the relay. The Remote User ID is an identity of the Remote UE user (provided via User Info) that was successfully connected in step 3. The SMF stores the Remote User IDs and the related IP info in the ProSe 5G UE-to-Network Relay's for the PDU connection associated with the relay.
   For IP info the following principles apply:
      for IPv4, the UE-to-network Relay shall report TCP/UDP port ranges assigned to individual Remote UE(s) (along with the Remote User ID);
      for IPv6, the UE-to-network Relay shall report IPv6 prefix(es) assigned to individual Remote UE(s) (along with the Remote User ID).
         The Remote UE Report message shall be sent when the Remote UE disconnects from the ProSe 5G UE-to-Network Relay (e.g. upon explicit layer-2 link release or based on the absence of keep alive messages over PC5) to inform the SMF that the Remote UE(s) have left.
         In the case of Registration Update procedure involving SMF change the Remote User IDs and related IP info corresponding to the connected Remote UEs are transferred to the new SMF as part of SM context transfer for the ProSe 5G UE-to-Network Relay.
NOTE 1: In order for the SMF to have the Remote UE(s) information, the HPLMN and the VPLMN where the ProSe 5G UE-to-Network Relay is authorised to operate, needs to support the transfer of the Remote UE related parameters in case the SMF is in the HPLMN.
NOTE 2: When Remote UE(s) disconnect from the ProSe UE-to-Network Relay, it is up to implementation how relaying PDU sessions are cleared/disconnected by the ProSe 5G UE-to-Network Relay.
   After being connected to the ProSe 5G UE-to-Network Relay, the Remote UE keeps performing the measurement of the signal strength of the discovery message sent by the ProSe 5G UE-to-Network Relay for relay reselection.
   The solution can also work when the ProSe 5G UE-to-Network Relay UE connects in EPS using LTE. In this case for the Remote UE report the procedures defined in TS 23.303 can be used.

In the 3GPP TR 23.752 v0.3.0 clause 6.7.2 and 6.7.3, the L2 UE-to-Network Relay UE is described as below.

In this clause, the protocol architecture supporting a L2 UE-to-Network Relay UE is provided.
The L2 UE-to-Network Relay UE provides forwarding functionality that can relay any type of traffic over the PC5 link.
The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.
FIG. 5 illustrates the protocol stack for the user plane transport, related to a PDU Session, including a Layer 2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP link are the Remote UE and the gNB. The relay function is performed below PDCP. This means that data security is ensured between the Remote UE and the gNB without exposing raw data at the UE-to-Network Relay UE.
The adaptation rely layer within the UE-to-Network Relay UE can differentiate between signalling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.
FIG. 6 illustrates the protocol stack of the NAS connection for the Remote UE to the NAS-MM and NAS-SM components. The NAS messages are transparently transferred between the Remote UE and 5G-AN over the Layer 2 UE-to-Network Relay UE using:
PDCP end-to-end connection where the role of the UE-to-Network Relay UE is to relay the PDUs over the signalling radio bear without any modifications.
N2 connection between the 5G-AN and AMF over N2.
N3 connection AMF and SMF over N11.
   The role of the UE-to-Network Relay UE is to relay the PDUs from the signaling radio bearer without any modifications.

### FIG. 6.7.3-1: Connection Establishment for Indirect Communication via UE-to-Network Relay UE in TR 23.752

0. If in coverage, the Remote UE and UE-to-Network Relay UE may independently perform the initial registration to the network according to registration procedures in TS 23.502. The allocated 5G GUTI of the Remote UE is maintained when later NAS signalling between Remote UE and Network is exchanged via the UE-to-Network Relay UE.
NOTE: The current procedures shown here assume a single hop relay.
1. If in coverage, the Remote UE and UE-to-Network Relay UE independently get the service authorization for indirect communication from the network.
2-3. The Remote UE and UE-to-Network Relay UE perform UE-to-Network Relay UE discovery and selection.
4. Remote UE initiates a one-to-one communication connection with the selected UE-to-Network Relay UE over PC5, by sending an indirect communication request message to the UE-to-Network Relay.
5. If the UE-to-Network Relay UE is in CM_IDLE state, triggered by the communication request received from the Remote UE, the UE-to-Network Relay UE sends a Service Request message over PC5 to its serving AMF.
   The Relay's AMF may perform authentication of the UE-to-Network Relay UE based on NAS message validation and if needed the AMF will check the subscription data.
   If the UE-to-Network Relay UE is already in CM_CONNECTED state and is authorised to perform Relay service then step 5 is omitted.
6. The UE-to-Network Relay UE sends the indirect communication response message to the Remote UE.
7. Remote UE sends a NAS message to the serving AMF. The NAS message is encapsulated in an RRC message that is sent over PC5 to the UE-to-Network Relay UE, and the UE-to-Network Relay UE forwards the message to the NG-RAN. The NG-RAN derives Remote UE's serving AMF and forwards the NAS message to this AMF.
NOTE: It is assumed that the Remote UE's PLMN is accessible by the UE-to-Network Relay's PLMN and that UE-to-Network Relay UE AMF supports all S-NSSAIs the Remote UE may want to connect to.
   If Remote UE has not performed the initial registration to the network in step 0, the NAS message is initial registration message. Otherwise, the NAS message is service request message.
   If the Remote UE performs initial registration via the UE-to-Network relay, the Remote UE's serving AMF may perform authentication of the Remote UE based on NAS message validation and if needed the Remote UE's AMF checks the subscription data.
   For service request case, User Plane connection for PDU Sessions can also be activated. The other steps follow the clause 4.2.3.2 in TS 23.502.
8. Remote UE may trigger the PDU Session Establishment procedure as defined in clause 4.3.2.2 of TS 23.502.
9. The data is transmitted between Remote UE and UPF via UE-to-Network Relay UE and NG-RAN. The UE-to-Network Relay UE forwards all the data messages between the Remote UE and NG-RAN using RAN specified L2 relay method.

In upcoming 3GPP Rel-17 study item (SI) on NR sidelink relay (see RP-193253, “New SID: Study on NR sidelink relay”), the below objectives will be studied during 3GPP Rel-17 time frame.

This study item targets to study single-hop NR sidelink-based relay.
1. Study mechanism(s) with minimum specification impact to support the SA requirements for sidelink-based UE-to-network and UE-to-UE relay, focusing on the following aspects (if applicable) for layer-3 relay and layer-2 relay [RAN2];
   A. Relay (re-)selection criterion and procedure;
   B. Relay/Remote UE authorization;
   C. QoS for relaying functionality;
   D. Service continuity;
   E. Security of relayed connection after SA3 has provided its conclusions;
   F. Impact on user plane protocol stack and control plane procedure, e.g., connection management of relayed connection;
2. Study mechanism(s) to support upper layer operations of discovery model/procedure for sidelink relaying, assuming no new physical layer channel/signal [RAN2];
NOTE 1: The study shall take into account of further input from SA WGs, e.g., SA2 and SA3, for the bullets above (if applicable).
NOTE 2: It is assumed that UE-to-network relay and UE-to-UE relay use the same relaying solution.
NOTE 3: Forward compatibility for multi-hop relay support in a future release needs to be taken into account.
NOTE 4: For layer-2 UE-to-network relay, the architecture of end-to-end PDCP and hop-by-hop RLC, e.g., as recommended in TR 36.746, is taken as starting point.

According to the above study objectives, SL based UE-to-network relay is one of the key study components. Both Layer 3 (L3) relay and Layer 2 (L2) relay will be studied.

As described above, the Buffer Size field of a BSR identifies the total amount of data available according to the data volume determined at the RLC and the PDCP layer across all logical channels of a logical channel group after the MAC PDU has been built (i.e. after the logical channel prioritization procedure, which may result the value of the Buffer Size field to zero).

For a remote UE connecting to radio access network (RAN) via a UE to network relay, the remote UE first transmits its data to the relay UE via a sidelink. After that, the relay UE relays the data to the gNB via a cellular link using a configured grant or a dynamic grant. In the case of configured grant, the relay UE can relay the data directly when receiving the data from the remote UE. In the case of dynamic grant, the relay UE needs to send SR and BSR to the gNB requesting a grant after receiving the data from the remote UE, which would cause additional latency for the data. This may be not acceptable for services associated with critical latency requirements.

Specifically for L2 relay, the remote UE's PDCP layer and lower layers including RLC and MAC are configured at different places. Therefore, its data volume of the PDCP layer cannot be informed to the MAC layer directly, which would lead to a case that a BSR generated at the MAC layer cannot contain the data volume of the PDCP layer. In other words, the data volume of the PDCP layer will be only reported to the gNB by the relay UE in case the PDCP PDUs are received by the relay UE via the sidelink. In such way, the gNB will not be able to assign UL grants to the relay UE in good time. This would cause latency. Therefore, it is necessary to study the above issues and develop corresponding solutions to reduce latency.

The present disclosure proposes an improved solution for resource allocation to terminal device. The solution may be proposed in view of a UE to network relay scenario where a remote UE transmits data to RAN via a relay UE. In this case, two issues are observed. The first issue is how the remote UE reports its data volume to RAN so that the gNB can schedule grants for the sidelink. The second issue is how the remote UE reports its data volume to the relay UE so that the relay UE may formulate a Uu BSR carrying both data volume of its pending data and coming data from the remote UE. In this way, the relay UE can trigger an early BSR/preemptive BSR to request grants ahead of the data arrival from the remote UE.

The solution of the present disclosure may be applied to a communication system including a terminal device and a base station. The terminal device can communicate through a radio access communication link with the base station. The base station can provide radio access communication links to terminal devices that are within its communication service cell. The base station may be, for example, a gNB in NR. Note that the communications may be performed between the terminal device and the base station according to any suitable communication standards and protocols. The terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

Now, several embodiments will be described on how a remote UE provides BSR reflecting upper layer data volume (PDCP or SDAP) to a gNB via a relay UE in case of UE to network relay. The embodiments are described in the context of NR, i.e., the remote UE and the relay UE are deployed in an NR cell. However, the embodiments are not limited to NR cell. They are also applicable to any UE to network relay such as LTE UE to network relay. The connection between a remote UE and a relay UE is also not limited to a sidelink. Any short range communication technology such as Wifi is equally applicable. The below embodiments are applicable to both L2 UE to network relay and L3 UE to network relay in case no specifically noted restriction.

In the first embodiment, a report mechanism regarding data volume is defined for a remote UE connecting to a UE to network relay. The remote UE reports its data volume to the relay UE and/or the gNB.

Upon reception of a report message from the remote UE, the relay UE can formulate a Uu BSR including its own data volume and/or the volume of the data of the remote UE which needs to be relayed via the relay UE. Upon reception of the BSR from the relay UE, the gNB is able to assign UL grants to the relay UE ahead for the data which will be relayed for the remote UE.

The report message received by the relay UE from the remote UE may be also relayed to the gNB via the relay UE. Upon reception of such report message, the gNB can assign grants to the sidelink.

For example, the report message may contain at least one of the below information:
1) buffer size for every LCG/LCH;
2) summarized buffer size for all LCGs/LCHs;
3) source UE ID for every LCG/LCH;
4) destination UE ID for every LCG/LCH;
5) an indicator indicating whether this message can be decoded/processed by a relay UE or not;
6) an indicator indicating whether this message needs to be relayed to the gNB.

Optionally, the report message may only contain the above information for LCGs/LCHs with data available.

For reporting data volume to the relay UE, the message may contain buffer size including both data pending for transmission and data being transmitted on the sidelink. By doing so, the relay UE will know the full data volume which will come to the relay UE from the remote UE.

For reporting data volume to the relay UE, the message may contain only data volume which needs to be relayed.

In the second embodiment, the remote UE reports its data volume to the relay UE via a PC5-RRC signaling message as a report message. If there is no PC5 RRC connection between the remote UE and the relay UE available, the remote UE can be triggered to establish a PC5 RRC connection towards the relay UE when the remote UE needs to report its data volume to the relay UE.

Alternatively, the remote UE may generate a PC5-RRC message which includes a container (i.e., OCTET STRING) containing a Uu RRC message that is used for reporting its data volume to the gNB. This PC5-RRC message is sent to the relay UE and the relay UE will be also responsible to forward, via the cellular link, the container (i.e., OCTET STRING) to the gNB.

In the third embodiment, the remote UE may use a BSR as a report message to report its data volume to the relay UE and/or the gNB. The BSR MAC CE can carry the same information as what is defined in the report message in the first embodiment.

For reporting data volume to the relay UE, a new type of BSR MAC CE may be defined.

Alternatively, the remote UE may use a Uu BSR to report its data volume to the relay UE.

For reporting data volume to the gNB, the remote UE may use existing sidelink (SL) BSR, which can be relayed to the gNB by the relay UE.

Alternatively, the remote UE may use sidelink (SL) BSR for reporting its data volume to both the relay UE and the gNB.

The indicators described in the first embodiment may be carried in the MAC subheader or in the MAC CE payload, as new fields or by reusing existing fields (e.g., R fields if applicable or any bits in another existing field).

This BSR MAC CE generated by the remote UE reflects buffer status at PC5-RLC layer and/or NR-PDCP layer.

In the fourth embodiment, after reception of a BSR MAC CE from a remote UE indicating its data volume (may only reflect data volume which need to be relayed by the relay UE), the relay UE may apply at least one of the below options to handle the BSR MAC CE.

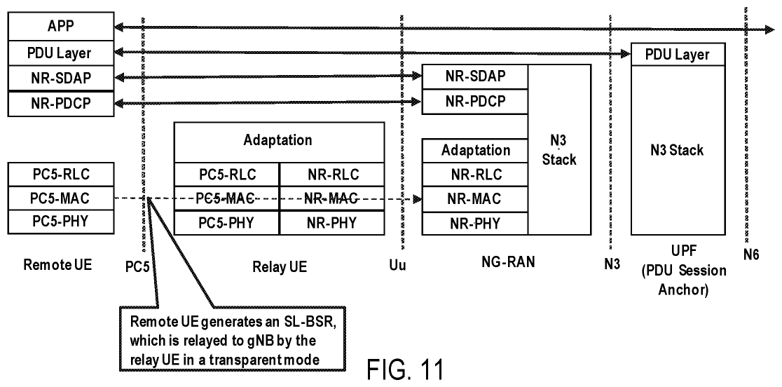

Option 1: The relay UE does not process/decode the received BSR MAC CE (e.g., an indicator in the BSR MAC CE indicating that the relay UE cannot process/decode this BSR MAC CE). The relay UE relays the BSR MAC CE to the gNB via the cellular link. In this case, the BSR MAC CE will only serve the purpose to report the data volume of the remote UE to the gNB. So that the gNB can assign a grant to the remote UE for the sidelink transmission. FIG. 11 illustrates an example of this option in case of L2 relay. As shown, the remote UE generates an SL-BSR, which is relayed to the gNB by the relay UE in a transparent mode.

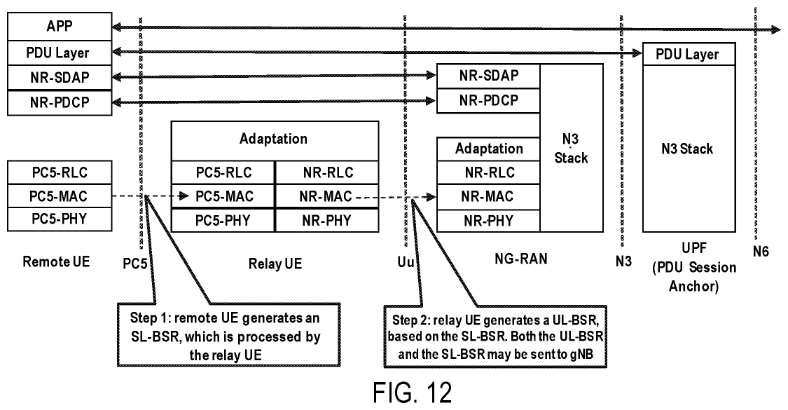

Option 2: The remote UE processes/decodes the BSR MAC CE (e.g., an indicator in the BSR MAC CE indicating that the relay UE can process/decode this BSR MAC CE). The relay UE can obtain the data volume of the remote UE which will need to be relayed. The relay UE can therefore build a Uu BSR to request a grant for the cellular link in advance. FIG. 12 illustrates an example of this option in case of L2 relay. As shown, at step 1, the remote UE generates an SL-BSR, which is processed by the relay UE. At step 2, the relay UE generates a UL-BSR based on the SL-BSR. Both the UL-BSR and the SL-BSR may be sent to gNB.

This Uu BSR may be named as a pre-emptive BSR or an early BSR for indicating data volume of a UE which will come in future. Such BSR can be triggered at a relay UE in case the relay UE has received a data volume report from a remote UE via a sidelink.

Alternatively, the relay UE may create a Uu BSR carrying both buffer size of coming data for relay from a relay UE and buffer size of existing data pending for transmission.

For Option 2, the gNB can obtain buffer size of coming data for relay from a relay UE. The gNB can therefore assign grants in advance to the relay UE. This is beneficial to reduce latency.

For option 2, the relay UE may also relay the received BSR MAC CE to the gNB. In this case, the gNB can obtain the buffer status for the sidelink so that the gNB can assign a grant to the remote UE for the sidelink transmission.

In addition to the indicator carried by a BSR, which option the relay UE shall apply to handle a received BSR MAC CE for indicating data volume of a remote UE may be configured by the gNB via signaling such as RRC, DCI or MAC CE. Alternatively, which option the relay UE shall apply to handle a received sidelink BSR MAC CE may be captured in a specification in a hard coded fashion.

In the fifth embodiment, the remote UE may report its data volume to the relay UE and/or the gNB via a report message in another layer such as an adaptation layer or PC5-RLC layer. For the former option, the adaptation layer needs to be configured above PC5-RLC for both the remote UE and the relay UE. For any of the two alternatives, a control PDU may be defined accordingly to carry the data volume for a remote UE.

In the sixth embodiment, the remote UE may report its data volume to the relay UE via a report message in NR upper layers (e.g., PDCP or SDAP or RRC). In this case, a control PDU at PDCP or SDAP may be defined for indicating data volume of the layer. In case RRC layer is used to carry the data volume of the remote UE, an RRC signaling message is generated to carry the data volume. In this embodiment, the relay UE may need to be aware of the security and/or integrity keys used by the remote UE in order to read/parse these control PDUs or RRC messages sent by the remote UE. This embodiment is only applicable to L2 UE to network relay.

In the seventh embodiment, in case the relay UE has already reported buffer size of coming data from a remote UE based on the report provided by the remote UE, it may or may not include again the data volume in another Uu BSR when it actually receives the data from the remote UE.

In the eighth embodiment, for any of the above embodiments, the report message for reporting data volume of a remote UE to a relay UE may in addition contain timing information which indicates the time when the data may be received by the relay UE. In this case, the relay UE may forward the timing information to the gNB. Based on such timing information, the gNB can assign respective UL grants to the relay UE ahead to transmit coming data from each respective remote UE. Those UL grants will be active at respective time instants corresponding to the arrival time of the data from each remote UE. Such information is useful especially in case multiple remote UEs are connecting to a same relay UE.

In the ninth embodiment, in case there are multiple remote UEs are connecting to a same relay UE, the relay UE may generate a BSR containing summarized buffer sizes of all received reported data volume of each remote UE. The summary may be performed per LCH/LCG across all remote UEs. In an example, each remote UE may be mapped to different LCHs/LCGs of the relay UE. In this case, the relay UE may generate a BSR carrying aggregated information (i.e., carrying buffer size (BS) of different LCHs/LCGs which are mapped to different remote UEs. In another example, multiple remote UEs may be mapped to a same LCH/LCG. In this case, the relay UE may generate a Uu BSR carrying summarized BS of this LCH/LCG among those remote UEs.

In the tenth embodiment, a relay UE is allowed to transmit multiple BSR MAC CEs (e.g., >2) in a same MAC PDU. In contrast, in the existing MAC specification, a UE can transmit at maximum two BSR MAC CEs (i.e., one SL BSR MAC CE and one Uu BSR MAC CE) in a same MAC PDU.

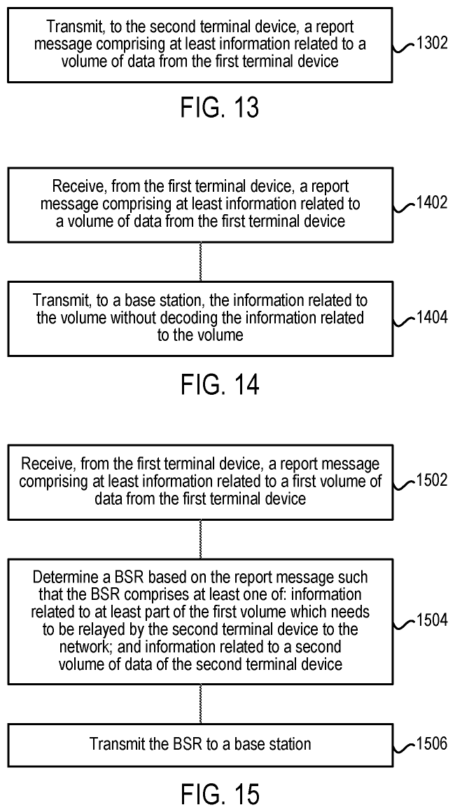

Hereinafter, the solution of the present disclosure will be further described with reference to FIGS. 13-31. FIG. 13 is a flowchart illustrating a method performed by a first terminal device according to an embodiment of the disclosure. The method is applicable to the case where the first terminal device connects to a network via a second terminal device acting as a relay therebetween. For example, the relay may be a UE-to-network relay. At block 1302, the first terminal device transmits, to the second terminal device, a report message comprising at least information related to a volume of data from the first terminal device to the second terminal device. For example, the volume of the data from the first terminal device to the second terminal device may comprise a data volume which needs to be relayed by the second terminal device to the network. The data from the first terminal device to the second terminal device may comprise at least one of: data to be transmitted (or pending for transmission) from the first terminal device to the second terminal device; and data being transmitted from the first terminal device to the second terminal device. Examples of the information related to the volume of the data from the first terminal device to the second terminal device may include, but not limited to, a buffer size for every LCG or LCH; buffer sizes for one or more LCGs or LCHs with data available; and a summarized buffer size for all LCGs or LCHs. The buffer size may comprise at least one of: a buffer size at an RLC layer; and a buffer size at a PDCP layer.

Optionally, the report message may further comprise at least one of following information: a source terminal device identity (ID) for every LCG or LCH; source terminal device IDs for one or more LCGs or LCHs with data available; a destination terminal device ID for every LCG or LCH; destination terminal device IDs for one or more LCGs or LCHs with data available; a first indicator indicating whether the report message can be decoded by the second terminal device; a second indicator indicating whether the report message needs to be relayed to the network; and timing information indicating a time when the data can be received by the second terminal device.

For example, the report message may be one of: an RRC message (e.g. a PC5-RRC message); a BSR (e.g. a sidelink BSR or a Uu BSR); a message in an adaptation layer; an RLC message (e.g. a PC5-RLC message); a PDCP message; and an SDAP message. Correspondingly, the above-mentioned information included in the report message may be carried by one of: a Uu RRC message contained in a container included in the PC5-RRC message; a PC5-RRC signaling information element included in the PC5-RRC message; an MAC CE of the BSR; an MAC subheader of the BSR; a control PDU of the adaptation layer; a control PDU of the RLC layer; a control PDU of the PDCP layer; and a control PDU of the SDAP layer. With the method of FIG. 13, it is possible to reduce latency for data transmissions, especially delay sensitive transmissions.

FIG. 14 is a flowchart illustrating a method performed by a second terminal device according to an embodiment of the disclosure. The method is applicable to the case where the second terminal device acts as a relay (e.g. a UE-to-network relay) between a first terminal device (e.g. one or more first terminal devices) and a network. At block 1402, the second terminal device receives, from the first terminal device, a report message comprising at least information related to a volume of data from the first terminal device to the second terminal device. Block 1402 corresponds to block 1302. At block 1404, the second terminal device transmits, to a base station, the information related to the volume without decoding the information related to the volume. For example, block 1404 may be performed according to at least one of: a first indicator included in the report message indicating that the report message cannot be decoded by the second terminal device; a second indicator included in the report message indicating that the report message needs to be relayed to the network; a signaling from the base station indicating that the report message cannot be decoded by the second terminal device; and a preconfiguration in the second terminal device. Examples of the signaling may include, but not limited to, an RRC signaling; a DCI; and an MAC CE. For example, the information related to the volume may be transmitted in one of an RRC message (e.g. a Uu RRC message) and a BSR (e.g. a sidelink BSR). With the method of FIG. 14, it is possible to reduce latency for data transmissions, especially delay sensitive transmissions.

FIG. 15 is a flowchart illustrating a method performed by a second terminal device according to an embodiment of the disclosure. The method is applicable to the case where the second terminal device acts as a relay (e.g. a UE-to-network relay) between a first terminal device (e.g. one or more first terminal devices) and a network. At block 1502, the second terminal device receives, from the first terminal device, a report message comprising at least information related to a first volume of data from the first terminal device to the second terminal device. Block 1502 corresponds to block 1302. At block 1504, the second terminal device determines a BSR based on the report message such that the BSR comprises at least one of: information related to at least part of the first volume which needs to be relayed by the second terminal device to the network; and information related to a second volume of data of the second terminal device. At block 1506, the second terminal device transmits the BSR to a base station. For example, blocks 1504 and 1506 may be performed according to at least one of: a first indicator included in the report message indicating that the report message can be decoded by the second terminal device; a second indicator included in the report message indicating that the report message needs to be relayed to the network; a signaling from the base station indicating that the report message can be decoded by the second terminal device; and a preconfiguration in the second terminal device. For example, with the second indicator, the second terminal device may first decode the report message according to the first indicator, then forward the report message to the base station according to the second indicator, even if the second terminal device has decoded the report message. By doing so, the base station can learn about the buffer status of the sidelink, and therefore, assign grants to the first terminal device for the sidelink transmission. Examples of the signaling may include, but not limited to, an RRC signaling; a DCI; and an MAC CE. With the method of FIG. 15, it is possible to reduce latency for data transmissions, especially delay sensitive transmissions. In a case where the information related to the at least part of the first volume is included in the BSR, a pre-emptive (or early) BSR can be introduced such that the base station is able to provide a grant to the second terminal device for its cellular link in advance of the data being received from the first terminal device.

Optionally, in a case where the information related to the at least part of the first volume included in the BSR comprises information related to a volume of data to be received from the first terminal device, when the second terminal device actually receives the data from the first terminal device, the volume of the data may or may not be included again in another BSR sent by the second terminal device to the base station.

As mentioned above, the second terminal device may act as a relay between multiple first terminal devices and the network. In this case, more than one report message may be received from more than one of the multiple first terminal devices. Optionally, the information related to the at least part of the first volumes corresponding to the more than one first terminal device may comprise one of: summarized buffer sizes of the more than one first terminal device; and a summarized buffer size for every LCG or LCH corresponding to the more than one first terminal device.

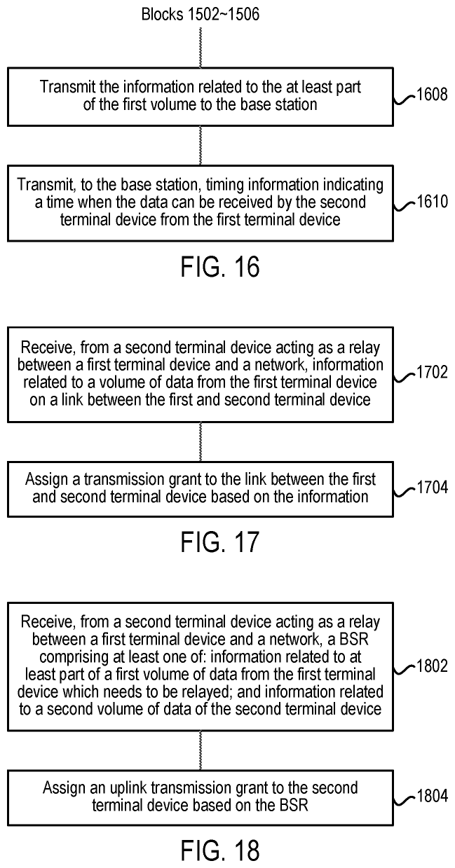

FIG. 16 is a flowchart illustrating a method performed by a second terminal device according to an embodiment of the disclosure. The method is applicable to the case where the second terminal device acts as a relay (e.g. a UE-to-network relay) between a first terminal device (e.g. one or more first terminal devices) and a network. As shown, the method comprises blocks 1502-1506, 1608 and 1610. Blocks 1502-1506 have been described above and their details are omitted here. At block 1608, the second terminal device transmits (or relays) the information related to the at least part of the first volume to the base station. Thus, the information included in the BSR may be sent in more than two BSR MAC CEs (e.g. a first BSR for NR-PDCP, a second BSR for the second terminal device, and a third BSR for NR sidelink) contained in a same MAC PDU. As described later, based on the relayed information, the base station may assign a transmission grant to the link between the first and second terminal device.

Optionally, the report message may further comprise timing information indicating a time when the data can be received by the second terminal device from the first terminal device. In this case, at block 1610, the second terminal device transmits the timing information to the base station. As described later, based on such timing information, the base station may assign an uplink transmission grant to the second terminal device.

FIG. 17 is a flowchart illustrating a method performed by a base station according to an embodiment of the disclosure. At block 1702, the base station receives, from a second terminal device acting as a relay (e.g. a UE-to-network relay) between a first terminal device and a network, information related to a volume of data from the first terminal device to the second terminal device on a link between the first and second terminal device. Block 1702 corresponds to block 1404. At block 1704, the base station assigns a transmission grant to the link between the first and second terminal device based on the information. With the method of FIG. 17, it is possible to reduce latency for data transmissions, especially delay sensitive transmissions.

FIG. 18 is a flowchart illustrating a method performed by a base station according to an embodiment of the disclosure. At block 1802, the base station receives, from a second terminal device acting as a relay (e.g. a UE-to-network relay) between a first terminal device and a network, a BSR comprising at least one of: information related to at least part of a first volume of data from the first terminal device which needs to be relayed by the second terminal device to the network; and information related to a second volume of data of the second terminal device. Block 1802 corresponds to block 1506. At block 1804, the base station assigns an uplink transmission grant to the second terminal device based on the BSR. With the method of FIG. 18, it is possible to reduce latency for data transmissions, especially delay sensitive transmissions. In a case where the information related to the at least part of the first volume is included in the BSR, a pre-emptive (or early) BSR can be introduced such that the base station is able to provide a grant to the second terminal device for its cellular link in advance of the data being received from the first terminal device.

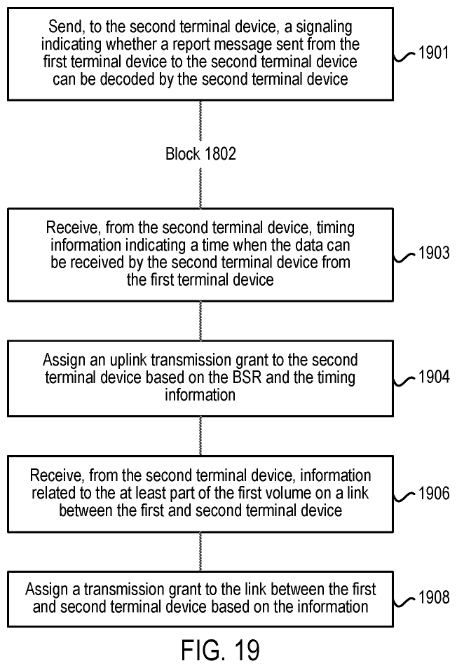

FIG. 19 is a flowchart illustrating a method performed by a base station according to an embodiment of the disclosure. As shown, the method comprises blocks 1901, 1802, 1903, 1904, 1906 and 1908. At block 1901, the base station sends, to the second terminal device, a signaling indicating whether a report message sent from the first terminal device to the second terminal device can be decoded by the second terminal device. The report message comprises at least information related to a volume of data from the first terminal device. As described above, whether the report message can be decoded by the second terminal device may be indicated by the above first indicator or may be preconfigured in the second terminal device. Thus, block 1901 is an optional block. At block 1802, the base station receives, from a second terminal device acting as a relay (e.g. a UE-to-network relay) between a first terminal device and a network, a BSR comprising at least one of: information related to at least part of a first volume of data from the first terminal device which needs to be relayed by the second terminal device to the network; and information related to a second volume of data of the second terminal device.

At block 1902, the base station receives, from the second terminal device, timing information indicating a time when the data can be received by the second terminal device from the first terminal device. Block 1902 corresponds to block 1610. At block 1904, the base station assigns an uplink transmission grant to the second terminal device based on the BSR and the timing information. In this way, the uplink grant can be active at respective time instants corresponding to the arrival time of the data from the first terminal device.

At block 1906, the base station receives, from the second terminal device, information related to the at least part of the first volume on a link between the first and second terminal device. Block 1906 corresponds to block 1608. At block 1908, the base station assigns a transmission grant to the link between the first and second terminal device based on the information.

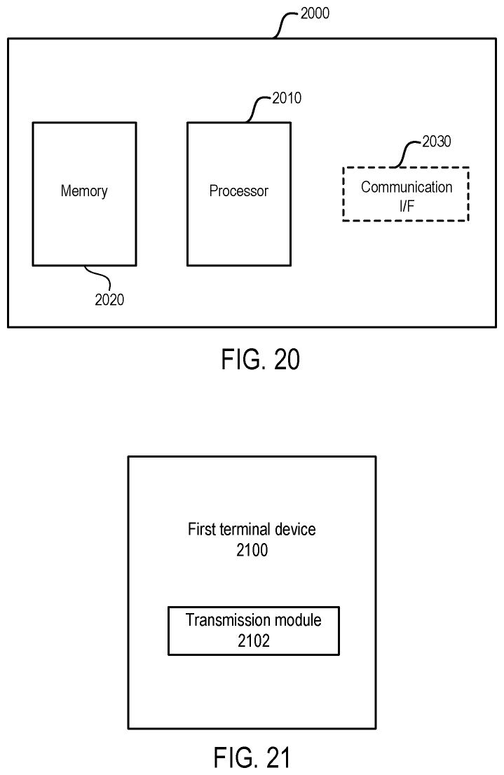

FIG. 20 is a block diagram showing an apparatus suitable for use in practicing some embodiments of the disclosure. For example, any one of the first terminal device, the second terminal device and the base station described above may be implemented through the apparatus 2000. As shown, the apparatus 2000 may include a processor 2010, a memory 2020 that stores a program, and optionally a communication interface 2030 for communicating data with other external devices through wired and/or wireless communication.

The program includes program instructions that, when executed by the processor 2010, enable the apparatus 2000 to operate in accordance with the embodiments of the present disclosure, as discussed above. That is, the embodiments of the present disclosure may be implemented at least in part by computer software executable by the processor 2010, or by hardware, or by a combination of software and hardware.

The memory 2020 may be of any type suitable to the local technical environment and may be implemented using any suitable data storage technology, such as semiconductor based memory devices, flash memories, magnetic memory devices and systems, optical memory devices and systems, fixed memories and removable memories. The processor 2010 may be of any type suitable to the local technical environment, and may include one or more of general purpose computers, special purpose computers, microprocessors, digital signal processors (DSPs) and processors based on multi-core processor architectures, as non-limiting examples.

FIG. 21 is a block diagram showing a first terminal device according to an embodiment of the disclosure. The first terminal device connects to a network via a second terminal device acting as a relay therebetween. As shown, the first terminal device 2100 comprises a transmission module 2102 configured to transmit, to the second terminal device, a report message comprising at least information related to a volume of data from the first terminal device to the second terminal device, as described above with respect to block 1302.

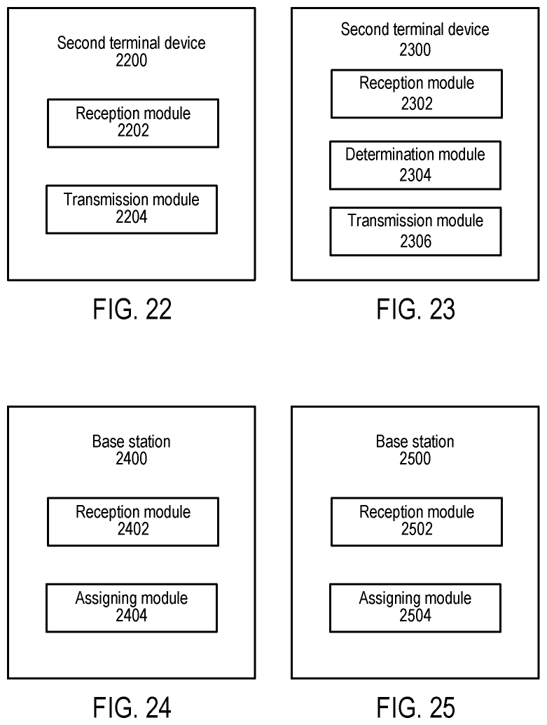

FIG. 22 is a block diagram showing a second terminal device according to an embodiment of the disclosure. The second terminal device acts as a relay between a first terminal device and a network. As shown, the second terminal device 2200 comprises a reception module 2202 and a transmission module 2204. The reception module 2202 may be configured to receive, from the first terminal device, a report message comprising at least information related to a volume of data from the first terminal device to the second terminal device, as described above with respect to block 1402. The transmission module 2204 may be configured to transmit, to a base station, the information related to the volume without decoding the information related to the volume, as described above with respect to block 1404.

FIG. 23 is a block diagram showing a second terminal device according to an embodiment of the disclosure. The second terminal device acts as a relay between a first terminal device and a network. As shown, the second terminal device 2300 comprises a reception module 2302, a determination module 2304 and a transmission module 2306. The reception module 2302 may be configured to receive, from the first terminal device, a report message comprising at least information related to a first volume of data from the first terminal device to the second terminal device, as described above with respect to block 1502. The determination module 2304 may be configured to determine a BSR based on the report message such that the BSR comprises at least one of: information related to at least part of the first volume which needs to be relayed by the second terminal device to the network; and information related to a second volume of data of the second terminal device, as described above with respect to block 1504. The transmission module 2306 may be configured to transmit the BSR to a base station, as described above with respect to block 1506.

FIG. 24 is a block diagram showing a base station according to an embodiment of the disclosure. As shown, the base station 2400 comprises a reception module 2402 and an assigning module 2404. The reception module 2402 may be configured to receive, from a second terminal device acting as a relay between a first terminal device and a network, information related to a volume of data from the first terminal device to the second terminal device on a link between the first and second terminal device, as described above with respect to block 1702. The assigning module 2404 may be configured to assign a transmission grant to the link between the first and second terminal device based on the information, as described above with respect to block 1704.

FIG. 25 is a block diagram showing a base station according to an embodiment of the disclosure. As shown, the base station 2500 comprises a reception module 2502 and an assigning module 2504. The reception module 2502 may be configured to receive, from a second terminal device acting as a relay between a first terminal device and a network, a BSR comprising at least one of: information related to at least part of a first volume of data from the first terminal device which needs to be relayed by the second terminal device to the network; and information related to a second volume of data of the second terminal device, as described above with respect to block 1802. The assigning module 2504 may be configured to assign an uplink transmission grant to the second terminal device based on the BSR, as described above with respect to block 1804. The modules described above may be implemented by hardware, or software, or a combination of both.

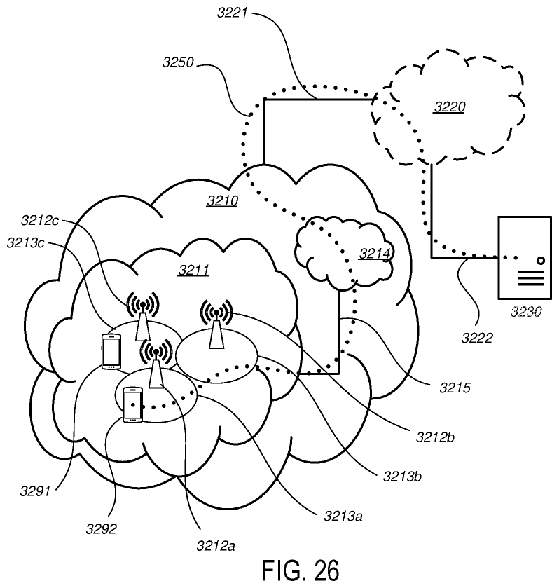

With reference to FIG. 26, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 26 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

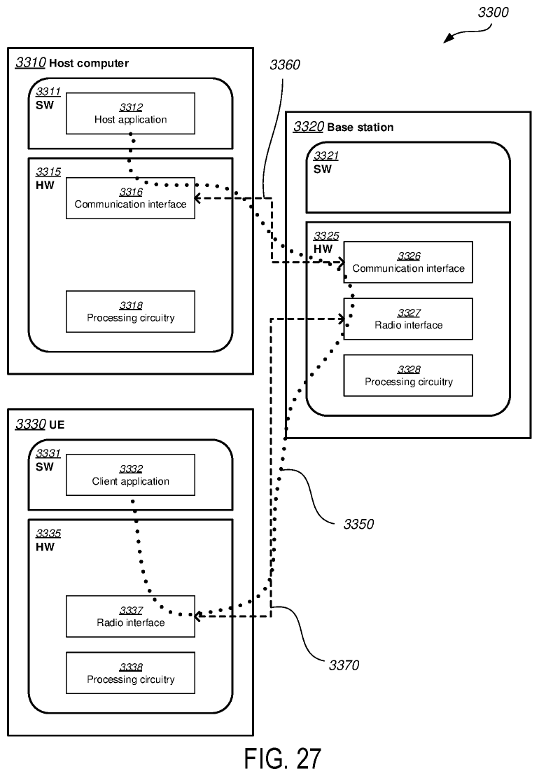

Example implementations, in accordance with an embodiment, of the UE, base station and host computer discussed in the preceding paragraphs will now be described with reference to FIG. 27. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 27) served by base station 3320. Communication interface 3326 may be configured to facilitate connection 3360 to host computer 3310. Connection 3360 may be direct or it may pass through a core network (not shown in FIG. 27) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3335 may include radio interface 3337 configured to set up and maintain wireless connection 3370 with a base station serving a coverage area in which UE 3330 is currently located. Hardware 3335 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 27 may be similar or identical to host computer 3230, one of base stations 3212a, 3212b, 3212c and one of UEs 3291, 3292 of FIG. 26, respectively. This is to say, the inner workings of these entities may be as shown in FIG. 27 and independently, the surrounding network topology may be that of FIG. 26.

In FIG. 27, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency and thereby provide benefits such as reduced user waiting time.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

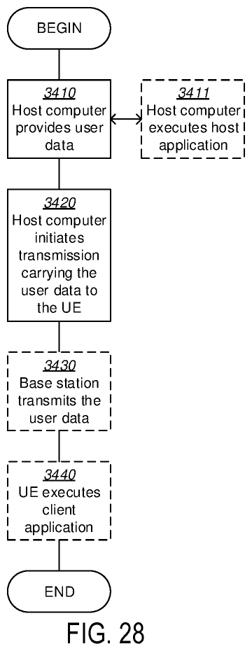

FIG. 28 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 28 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

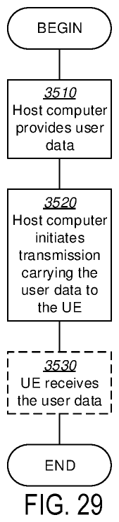

FIG. 29 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 29 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

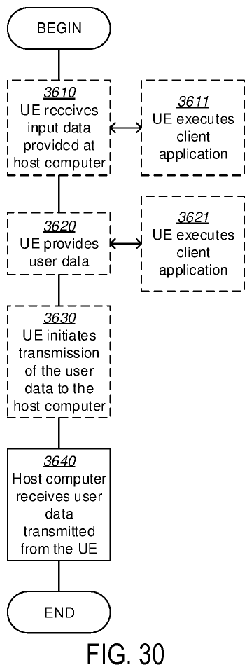

FIG. 30 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 30 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

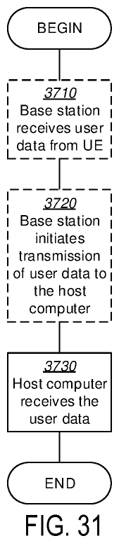

FIG. 31 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 31 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

According to an aspect of the disclosure, there is provided a method implemented in a communication system including a host computer, a base station and a second terminal device. The method comprises, at the host computer, receiving user data transmitted to the base station from the second terminal device. The second terminal device acts as a relay between a first terminal device and a network. The second terminal device receives, from the first terminal device, a report message comprising at least information related to a volume of data from the first terminal device to the second terminal device. The second terminal device transmits, to a base station, the information related to the volume without decoding the information related to the volume.

In an embodiment of the disclosure, the method may further comprise, at the second terminal device, providing the user data to the base station.

In an embodiment of the disclosure, the method may further comprise, at the second terminal device, executing a client application, thereby providing the user data to be transmitted. The method may further comprise, at the host computer, executing a host application associated with the client application.

In an embodiment of the disclosure, the method may further comprise, at the second terminal device, executing a client application. The method may further comprise, at the second terminal device, receiving input data to the client application. The input data may be provided at the host computer by executing a host application associated with the client application. The user data to be transmitted may be provided by the client application in response to the input data.

According to another aspect of the disclosure, there is provided a communication system including a host computer comprising a communication interface configured to receive user data originating from a transmission from a second terminal device to a base station. The second terminal device comprises a radio interface and processing circuitry. The second terminal device acts as a relay between a first terminal device and a network. The processing circuitry of the second terminal device is configured to receive, from the first terminal device, a report message comprising at least information related to a volume of data from the first terminal device to the second terminal device. The processing circuitry of the second terminal device is configured to transmit, to a base station, the information related to the volume without decoding the information related to the volume.

In an embodiment of the disclosure, the communication system may further include the second terminal device.

In an embodiment of the disclosure, the communication system may further include the base station. The base station may comprise a radio interface configured to communicate with the second terminal device and a communication interface configured to forward to the host computer the user data carried by a transmission from the second terminal device to the base station.

In an embodiment of the disclosure, the processing circuitry of the host computer may be configured to execute a host application. The processing circuitry of the second terminal device may be configured to execute a client application associated with the host application, thereby providing the user data.

In an embodiment of the disclosure, the processing circuitry of the host computer may be configured to execute a host application, thereby providing request data. The processing circuitry of the second terminal device may be configured to execute a client application associated with the host application, thereby providing the user data in response to the request data.

According to another aspect of the disclosure, there is provided a method implemented in a communication system including a host computer, a base station and a second terminal device. The method comprises, at the host computer, receiving user data transmitted to the base station from the second terminal device. The second terminal device acts as a relay between a first terminal device and a network. The second terminal device receives, from the first terminal device, a report message comprising at least information related to a first volume of data from the first terminal device to the second terminal device. The second terminal device determines a BSR based on the report message such that the BSR comprises at least one of: information related to at least part of the first volume which needs to be relayed by the second terminal device to the network; and information related to a second volume of data of the second terminal device. The second terminal device transmits the BSR to a base station.

In an embodiment of the disclosure, the method may further comprise, at the second terminal device, providing the user data to the base station.

In an embodiment of the disclosure, the method may further comprise, at the second terminal device, executing a client application, thereby providing the user data to be transmitted. The method may further comprise, at the host computer, executing a host application associated with the client application.

In an embodiment of the disclosure, the method may further comprise, at the second terminal device, executing a client application. The method may further comprise, at the second terminal device, receiving input data to the client application. The input data may be provided at the host computer by executing a host application associated with the client application. The user data to be transmitted may be provided by the client application in response to the input data.

According to another aspect of the disclosure, there is provided a communication system including a host computer comprising a communication interface configured to receive user data originating from a transmission from a second terminal device to a base station. The second terminal device comprises a radio interface and processing circuitry. The second terminal device acts as a relay between a first terminal device and a network. The processing circuitry of the second terminal device is configured to receive, from the first terminal device, a report message comprising at least information related to a first volume of data from the first terminal device to the second terminal device. The processing circuitry of the second terminal device is further configured to determine a BSR based on the report message such that the BSR comprises at least one of: information related to at least part of the first volume which needs to be relayed by the second terminal device to the network; and information related to a second volume of data of the second terminal device. The processing circuitry of the second terminal device is further configured to transmit the BSR to a base station.

In an embodiment of the disclosure, the communication system may further include the second terminal device.

In an embodiment of the disclosure, the communication system may further include the base station. The base station may comprise a radio interface configured to communicate with the second terminal device and a communication interface configured to forward to the host computer the user data carried by a transmission from the second terminal device to the base station.

In an embodiment of the disclosure, the processing circuitry of the host computer may be configured to execute a host application. The processing circuitry of the second terminal device may be configured to execute a client application associated with the host application, thereby providing the user data.

In an embodiment of the disclosure, the processing circuitry of the host computer may be configured to execute a host application, thereby providing request data. The processing circuitry of the second terminal device may be configured to execute a client application associated with the host application, thereby providing the user data in response to the request data.

According to another aspect of the disclosure, there is provided a method implemented in a communication system including a host computer, a base station and a second terminal device. The method comprises, at the host computer, receiving, from the base station, user data originating from a transmission which the base station has received from the second terminal device. The base station receives, from a second terminal device acting as a relay between a first terminal device and a network, information related to a volume of data from the first terminal device to the second terminal device on a link between the first and second terminal device. The base station assigns a transmission grant to the link between the first and second terminal device based on the information.

In an embodiment of the disclosure, the method may further comprise, at the base station, receiving the user data from the second terminal device.

In an embodiment of the disclosure, the method may further comprise, at the base station, initiating a transmission of the received user data to the host computer.

According to another aspect of the disclosure, there is provided a communication system including a host computer comprising a communication interface configured to receive user data originating from a transmission from a second terminal device to a base station. The base station comprises a radio interface and processing circuitry. The base station's processing circuitry is configured to receive, from a second terminal device acting as a relay between a first terminal device and a network, information related to a volume of data from the first terminal device to the second terminal device on a link between the first and second terminal device. The base station's processing circuitry is further configured to assign a transmission grant to the link between the first and second terminal device based on the information.

In an embodiment of the disclosure, the communication system may further include the base station.

In an embodiment of the disclosure, the communication system may further include the second terminal device. The second terminal device may be configured to communicate with the base station.

In an embodiment of the disclosure, the processing circuitry of the host computer may be configured to execute a host application. The second terminal device may be configured to execute a client application associated with the host application, thereby providing the user data to be received by the host computer.

According to another aspect of the disclosure, there is provided a method implemented in a communication system including a host computer, a base station and a second terminal device. The method comprises, at the host computer, receiving, from the base station, user data originating from a transmission which the base station has received from the second terminal device. The base station receives, from a second terminal device acting as a relay between a first terminal device and a network, a BSR comprising at least one of: information related to at least part of a first volume of data from the first terminal device which needs to be relayed by the second terminal device to the network; and information related to a second volume of data of the second terminal device. The base station assigns an uplink transmission grant to the second terminal device based on the BSR.

In an embodiment of the disclosure, the method may further comprise, at the base station, receiving the user data from the second terminal device.

In an embodiment of the disclosure, the method may further comprise, at the base station, initiating a transmission of the received user data to the host computer.

According to another aspect of the disclosure, there is provided a communication system including a host computer comprising a communication interface configured to receive user data originating from a transmission from a second terminal device to a base station. The base station comprises a radio interface and processing circuitry. The base station's processing circuitry is configured to receive, from a second terminal device acting as a relay between a first terminal device and a network, a BSR comprising at least one of: information related to at least part of a first volume of data from the first terminal device which needs to be relayed by the second terminal device to the network; and information related to a second volume of data of the second terminal device. The base station's processing circuitry is further configured to assign an uplink transmission grant to the second terminal device based on the BSR.

In an embodiment of the disclosure, the communication system may further include the base station.

In an embodiment of the disclosure, the communication system may further include the second terminal device. The second terminal device may be configured to communicate with the base station.

In an embodiment of the disclosure, the processing circuitry of the host computer may be configured to execute a host application. The second terminal device may be configured to execute a client application associated with the host application, thereby providing the user data to be received by the host computer.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It should be noted that two blocks shown in succession in the figures may, in fact, be executed substantially concurrently, or the blocks may sometimes be executed in the reverse order, depending upon the functionality involved.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a first terminal device, wherein the first terminal device connects to a network via a second terminal device acting as a relay between the first terminal device and the network, the method comprising:
transmitting, to the second terminal device, a report message comprising at least information related to a volume of data from the first terminal device to the second terminal device.

2. The method according to claim 1, wherein the volume of the data from the first terminal device to the second terminal device comprises a data volume which needs to be relayed by the second terminal device to the network.

3. The method according to claim 1, wherein the data from the first terminal device to the second terminal device comprises one or more of:
data to be transmitted from the first terminal device to the second terminal device; and
data being transmitted from the first terminal device to the second terminal device.

4. The method according to claim 1, wherein the information related to the volume of the data from the first terminal device to the second terminal device comprises one or more of:
a buffer size for every logical channel group (LCG) or logical channel (LCH);
buffer sizes for one or more LCGs or LCHs with data available; and
a summarized buffer size for all LCGs or LCHs.

5. The method according to claim 4, wherein the buffer size comprises one or more of:
a buffer size at a radio link control (RLC) layer; and
a buffer size at a packet data convergence protocol (PDCP) layer.

6. The method according to claim 1, wherein the report message further comprises:
a source terminal device identity, (ID), for every logical channel group (LCG) or logical channel (LCH);
source terminal device IDs for one or more LCGs or LCHs with data available;
a destination terminal device ID for every LCG or LCH;
destination terminal device IDs for one or more LCGs or LCHs with data available;
a first indicator indicating whether the report message can be decoded by the second terminal device;
a second indicator indicating whether the report message needs to be relayed to the network;
timing information indicating a time when the data can be received by the second terminal device; or
any combination thereof.

7. The method according to claim 1, wherein the report message is:
a radio resource control (RRC) message;
a buffer status report (BSR);
a message in an adaptation layer;
an radio link control (RLC) message;
a packet data convergence protocol (PDCP) message; or
a service data adaptation protocol (SDAP) message.

8. The method according to claim 7, wherein the RRC message is a PC5-RRC message, the RLC message is a PC5-RLC message, or both the RRC message is the PC5-RRC message and the RLC message is the PC5-RLC message.

9. The method according to claim 8, wherein the information included in the report message is carried by:
a Uu RRC message contained in a container included in the PC5-RRC message;
a PC5-RRC signaling information element included in the PC5-RRC message;
a media access control (MAC) control element (CE) of the BSR;
an MAC subheader of the BSR;
a control protocol data unit (PDU) of the adaptation layer;
a control PDU of a RLC layer;
a control PDU of a PDCP layer; or
a control PDU of a SDAP layer.

10. The method according to claim 7, wherein the BSR is a sidelink BSR or a Uu BSR.

11. A method performed by a second terminal device, wherein the second terminal device acts as a relay between a first terminal device and a network, the method comprising:
receiving, from the first terminal device, a report message comprising at least information related to a volume of data from the first terminal device to the second terminal device; and
transmitting, to a base station, the information related to the volume without decoding the information related to the volume.

12. The method according to claim 11, wherein the transmitting of the information related to the volume is performed according to one or more of:
a first indicator included in the report message indicating that the report message cannot be decoded by the second terminal device;
a second indicator included in the report message indicating that the report message needs to be relayed to the network;
a signaling from the base station indicating that the report message cannot be decoded by the second terminal device; and
a preconfiguration in the second terminal device.

13. The method according to claim 12, wherein the signaling is:
a radio resource control (RRC) signaling;
a downlink control information (PCI); or
a media access control (MAC) control element (CE).

14. The method according to claim 11, wherein the information related to the volume is transmitted in:
an RRC message; or
a buffer status report (BSR).

15. The method according to claim 14, wherein the RRC message is a Uu RRC message, the BSR is a sidelink BSR or the RRC message is the Uu RRC message and the BSR is the sidelink BSR.

16-30. (canceled)

31. A first terminal device, wherein the first terminal device (2000) connects to a network via a second terminal device acting as a relay between the first terminal device and the network, the first terminal device comprising:
at least one processor; and
at least one memory, the at least one memory containing instructions which, when executed by the at least one processor, cause the first terminal device to:
transmit, to the second terminal device, a report message comprising at least information related to a volume of data from the first terminal device to the second terminal device.

32-40. (canceled)

41. The first terminal device according to claim 31, wherein the volume of the data from the first terminal device to the second terminal device comprises a data volume which needs to be relayed by the second terminal device to the network.

42. The first terminal device according to claim 31, wherein the information related to the volume of the data from the first terminal device to the second terminal device comprises one or more of:
a buffer size for every logical channel group (LCG) or logical channel (LCH);
buffer sizes for one or more LCGs or LCHs with data available; and
a summarized buffer size for all LCGs or LCHs.

43. The first terminal device according to claim 42, wherein the buffer size comprises one or more of:
a buffer size at a radio link control (RLC) layer; and
a buffer size at a packet data convergence protocol (PDCP) layer.

44. The first terminal device according to claim 31, wherein the report message further comprises:
a source terminal device identity (ID) for every logical channel group (LCG) or logical channel (LCH);
source terminal device IDs for one or more LCGs or LCHs with data available;
a destination terminal device ID for every LCG or LCH;
destination terminal device IDs for one or more LCGs or LCHs with data available;
a first indicator indicating whether the report message can be decoded by the second terminal device;
a second indicator indicating whether the report message needs to be relayed to the network;
timing information indicating a time when the data can be received by the second terminal device; or
any combination thereof.
